(19) United States
(12) Patent Application Publication
(10) Pub. No.: US 2015/0271774 A1
(43) Pub. Date: Sep. 24, 2015

(54) SYSTEM AND METHOD FOR PROVISION OF A LOCAL SECOND LINE SERVICE TO A ROAMING TELECOMMUNICATIONS DEVICE USING MIXED PROTOCOLS

(71) Applicants: George Backhaus, Suwanee, GA (US); Jignesh Gandhi, Duluth, GA (US); Julio Gonzalez, Tucker, GA (US); John Green, Roswell, GA (US); Philip Lowman, Ellijay, GA (US); Paul Rubenstein, Johns Creek, GA (US); Mike Speanburg, Lawrenceville, GA (US)

(72) Inventors: George Backhaus, Suwanee, GA (US); Jignesh Gandhi, Duluth, GA (US); Julio Gonzalez, Tucker, GA (US); John Green, Roswell, GA (US); Philip Lowman, Ellijay, GA (US); Paul Rubenstein, Johns Creek, GA (US); Mike Speanburg, Lawrenceville, GA (US)

(21) Appl. No.: 14/727,559

(22) Filed: Jun. 1, 2015

Related U.S. Application Data
(63) Continuation-in-part of application No. 13/920,056, filed on Jun. 17, 2013.
Application No. 13/920,056 is a continuation-in-part of application No. 13/466,074, filed on May 7, 2012.
Application No. 13/466,074 is a continuation-in-part of application No. 14/307,407, filed on Jun. 17, 2014.
Application No. 14/307,407 is a continuation-in-part of application No. 12/133,996, filed on Jun. 5, 2008, now abandoned.
(60) Provisional application No. 61/660,772, filed on Jun. 17, 2012.
(60) Provisional application No. 61/836,145, filed on Jun. 17, 2013.

(51) Int. Cl. H04W 60/04; H04M 15/00

(52) U.S. Cl. CPC H04W 60/04; H04M 15/8038; H04M 2215/34

(57) ABSTRACT

A method for servicing an SLS based communication request between a third party TD that is situated inside of the locality serviced by its primary service provider network and a TD associated with an SLS subscriber that is situated outside of the locality serviced by its primary service provider network involves associating the local SLS phone number of the subscriber, the primary number of the subscriber and the primary number of a third party via a common relationship number. Calls directed from a third party to the SLS phone number of a subscriber are routed to an SLS platform and redirected to the subscriber TD. Calls directed from the subscriber TD to the third party use the relationship number to route the call to the SLS platform. The combination of the primary service number and the relationship number identifies the third party number for call completion.

### BACKGROUND

In simpler times, communication meant a face to face conversation, a hand written note or, perhaps, a phone call between two land lines. Times have changed. People today communicate constantly and simultaneously via myriad channels, most of which are mobile. Of all the means of communication available to today's users, the mobile telecommunication device (“MTD”) may be the most ubiquitous. This is especially true for users that do a lot of travel outside of their home telecommunications network (“home locality”).

MTDs, along with their mobile telecommunications service (“mobile service”), have fundamentally changed the ways in which travelers remain in communication with those in their home locality and the ways in which travelers communicate with those in foreign localities. In the past, travelers had to provide their loved ones, business contacts, and anyone else they wanted to remain in contact with, a local mailing address for tangible written correspondence. As time passed, tangible written correspondence gave way to telephones, so travelers had to provide a local telephone number instead.

Luckily, with the advent of MTDs, travelers can now take their telecommunications devices, associated mobile service and telephone number with them so long as certain specific circumstances are in place. First, there must be an accessible mobile service provider in the traveled to locality (“roamed-to mobile service provider”). Second, there must be an established agreement between this roamed-to mobile service provider and the traveler's primary mobile service provider (“home mobile service provider”) that allows the traveling subscriber to use its mobile service while connected to (“roaming on”) the roamed-to mobile service provider's network (“roamed-to MS provider's network”). Third, the home mobile service provider must offer the traveling subscriber with roaming service on the roamed-to MS provider's network. Fourth, and finally, the traveling subscriber's MTD must be compatible and capable of connecting to the roamed-to MS provider's network.

When all of these circumstances are in place, traveling subscribers can use their MTDs to stay connected, keep their busy lives moving forward, and fulfill their endless responsibilities without the need of relying on local mail or telecommunications services. However, despite the many benefits that modern roaming mobile telecommunications services (“roaming mobile services”) provide to traveling subscribers, these roaming mobile services suffer from some serious limitations.

First, for many travelers, the endless responsibilities that are dealt with through the use of MTDs are of a personal and professional mix. Fielding phone calls and texts from family and friends on the same mobile device from which you endeavor to conduct business is a recipe for confusion. For example, when taking a call from your top client, it's probably a good idea to avoid getting it mixed up with a call from your spouse. The greeting “Hey, Honey!” can undermine even the best of business relationships.

Second, when the subscriber is traveling in the locality of its top client, the client may suffer the inconvenience of having to make a long-distance phone call when it calls the subscriber. Why should the client be charged a long-distance fee for calling a subscriber in the same locality?

As such, not only may it be prohibitively expensive for many travelers to take advantage of their roaming mobile services when keeping the personal and business channels of communication separated, it may also be prohibitively expensive for those not in the traveling subscriber's home mobile service provider's network (“home MS provider's network”) to communicate with the traveler when he or she is roaming.

For example, with regard to voice communications, when a traveling subscriber initiates a roaming voice communication: to a TD within the roamed-to MS provider's network; to a TD within their home MS provider's network; or to another mobile service provider's network (“MS provider's network”), a charge is usually applied to the traveling subscriber that initiates the call (depending on the roaming agreement between the two respective telecommunications service providers). It is possible, but not usual, that the TD receiving the voice communication is charged as well. The charge applied to the traveling subscriber is usually significantly higher than the charge to subscribers of the roamed-to mobile service provider.

Conversely, when a traveling subscriber receives a voice communication: from a TD within the roamed-to MS provider's network; from a TD within their home MS provider's network; or from another MS provider's network, two charges are usually applied. One charge is applied to the TD that initiates the voice communication (“the initiator”) and a separate charge is applied to the traveling subscriber. The charge to the initiator is usually the standard charge it would face for initiating a voice communication with the traveling subscriber as if it were on its home MS provider's network. The charge to the traveling subscriber is usually a previously established rate for receiving a voice communication via roaming as mandated by their home mobile service provider. This charge is usually significantly higher than non-roaming charges.

With regard to SMS communications, when a traveling subscriber initiates an SMS: to a TD within the roamed-to MS provider's network; to a TD within their home MS provider's network; or to another mobile service provider's network (“MS provider's network”), a charge is usually applied to the traveling subscriber that initiates the SMS (again, depending on the roaming agreement between the two respective telecommunications service providers). It is possible, but not usual, that the TD receiving the SMS is charged as well. The charge applied to the traveling subscriber is usually significantly higher than the charge to subscribers of the roamed-to mobile service provider.

Conversely, when a traveling subscriber receives an SMS: from a TD within the roamed-to MS provider's network; from a TD within their home MS provider's network; or from another MS provider's network, a charge is usually applied to the TD that initiates the SMS (“the initiator”) (again, depending on the roaming agreement between the two respective telecommunications service providers). It is possible, but not usual, that the traveling subscriber receiving the SMS is charged as well. The charge to the initiator is usually the standard charge it would face for initiating an SMS with the traveling subscriber as if it were on its home MS provider's network. The charge, if any, to the traveling subscriber is usually a previously established rate for receiving an SMS via international roaming as mandated by their home mobile service provider. This charge is usually significantly higher than non-roaming charges.

To keep the personal and business channels of communication separated, many subscribers simply carry two separate MTDs, each with its own dedicated phone number and service options. If MTD “A” rings, the user knows it's of a personal nature; if MTD “B” rings, the user knows that it's a business related call.

To deal with the prohibitively expensive charges associated with a roaming mobile service, a traveler that plans to stay in a foreign locality for a substantial period of time may choose to carry MTDs “A” subscribed to the traveler's home MS provider's network and “B” subscribed to the mobile service provider in the traveled to locality (“foreign mobile service provider”). If the traveler wishes to initiate or receive telecommunications from a TD within the foreign mobile service provider's network (“foreign MS provider's network”), then the traveler will use the foreign mobile service provider MTD to minimize the charges to itself and the third party. If the traveler wishes to initiate or receive telecommunications from a TD within its home MS provider's network or from another MS provider's network, then the traveler must calculate which of its two MTDs minimizes the charges to itself and the third party because the roaming charges may be greater than the out-of-network charges or vice versa.

Consequently, while carrying two MTDs is one possible solution for keeping the personal and business channels of communication separated and for the prohibitively expensive charges associated with a roaming mobile service, a traveler having to keep track of two MTDs and their related mobile service can be frustrating, complicated and expensive.

For many travelers, porting a second phone number with its associated mobile service to a single MTD makes more sense—in doing so, at least the number of devices that must be kept up with have been reduced. But current systems and methods for managing multiple phone numbers on a single MTD are not without issues. For example, a traveler can carry a dual-SIM (“subscriber identity module”) MTD, with each SIM card being dedicated to a separate mobile service, but the cost of two separate mobile service plans to accommodate the multiple SIM cards, not to mention the cost of the dual-SIM phone itself, can be exorbitant. These costs can be reduced by the traveler switching out the SIM in its MTD depending on whether it wants to use its roaming mobile service or the mobile service in the traveled to locality; however, this only reduces the cost to the traveler while increasing its effort and frustration.

Accordingly, what is needed is a more efficient and effective system and method for providing a plurality of dedicated mobile services to a single MTD in such a manner that the user of the MTD can separate and manage communications on each. Further, what is needed is a system and method for providing a second line service (“an SLS”) to an MTD in such a manner that only a single primary phone number is required from the device's home mobile service provider. Even further, what is needed is a system and method for providing an SLS to an MTD in such a manner that the SLS can be provided to the traveling subscriber without having to coordinate with the traveling subscriber's home mobile service provider.

### SUMMARY OF THE DISCLOSURE

A method and system are described for servicing an SLS based communication request between a third party TD that is situated inside of the locality serviced by its primary service provider network and a TD associated with an SLS subscriber that is situated outside of the locality serviced by its primary service provider network. The various embodiments of the method and system may operate in an environment in which an SLS platform is interposed between a network serving a subscriber's TD and a network serving a third party TD. Notably, depending on the particular embodiment, if the subscriber's TD is situated outside of the locality serviced by its primary service provider network then one of the provider networks may be a secondary service provider network that is servicing the “roaming” subscriber's TD. The same is true for third party TD 120. As such, an SLS based communication request originating from a third party TD and directed towards the SLS number associated with the TD of an SLS subscriber, is routed by the receiving network to an SLS platform or server for processing.

As one of ordinary skill in the art will recall, the provider network routes a call based on the SLS phone number associated with the SLS subscriber. However, depending on which provider network the SLS phone number is associated, a call directed at/directed from the SLS phone number is usually routed through its associated provider network before terminating at the SLS platform. For example, if the SLS phone number is associated with one provider network, then any call direct at/directed from the SLS phone number is routed through this provider network regardless of the SLS phone number being owned, lease, or assigned, etc. by a separate SLS provider. Consequently, it is envisioned that the SLS provider can maintain a large and diverse inventory of SLS phone numbers; each being associated with its respective provider network and, consequently, each routing through its associated provider network before terminating at the SLS platform.

Upon receiving the call, the SLS platform queries a local database to identify a relationship number that serves to map the primary number of the subscriber's TD to the combination of the third party calling number and the subscriber's second line number. The call is then redirected to the primary number of the subscriber's TD along with or in addition to, information that identifies the call as being directed to the SLS number. Once received by the subscriber's TD, the call setup is completed. Additional information may be included within the call signal such that an application running, associated with or resident on the subscriber's TD can save the combination in a local database on the subscriber's TD.

Advantageously, the relationship number so delivered to the subscriber's TD can be used at a later time to initiate an SLS based call to a third party. As a non-limiting example, dialing the third party's telephone number or otherwise initiating a call to the third party from the SLS application on the subscriber's TD can result in dialing or initiating a call to the relationship number for the third party. As such, when the call enters the telephone network (such as the PSTN, MTSO, etc.) the call is actually routed to the SLS platform. The SLS platform may then use the relationship number to identify the actual destination number of the third party and the SLS number that is attributed to being the originator of the call. Next, the SLS platform routes, bridges, transfers, initiates or otherwise establishes a completed communication path, or the delivery of a message from the originating TD to the destination TD. As a non-limiting example, using the actual third party called number, the SLS platform may complete the second leg of the call. In certain embodiments, a call leg between a subscriber's TD and the SLS platform may be completed using a session initiated protocol (“SIP”) so that the data service provided by the primary service provider of the subscriber device is used in lieu of a voice channel.

However, if a subscriber TD attempts to direct an SLS based call to a third party number the does not have an associated relationship number, the call may be directed to, or invoke the routing of the call to the SLS platform by placing the call to a new relationship number selected by an SLS client application running on the subscriber's TD. In such case, the relationship number invokes the telecommunications network to route the call to the SLS platform and the third party number is provided to the SLS platform from the subscriber's TD. In other embodiments, the new relationship number may be requested from the SLS platform before making the call and then used by the subscriber's TD to make the call. In either case, a new relationship number is used to direct the call from the subscriber's TD toward the third party destination and to trigger the telecommunications network to route the call to the SLS platform.

In the databases located at or accessible to the subscriber's TD and the SLS platform, the new relationship number maps the subscriber's primary number to the combination of the third party number and the subscriber's second line number. The call is redirected by the SLS platform to the number associated with the third party TD and the call is completed. Advantageously, the new relationship number can be used at a later time should the subscriber desire to call the third party as previously described.

By associating the SLS phone number of the subscriber, the primary number of the subscriber and the phone number of a third party via a common relationship number, SLS based calls can be directed to and from an SLS of a subscriber TD.

In certain specific embodiments of the present invention, the SLS phone number for a subscriber's TD issued by the SLS provider is a phone number associated with the network servicing the roaming locality of the subscriber TD 110. As such, the SLS phone number is a local phone number relative to the primary phone number of a third party TD in the same locality and any calls directed to or directed from the SLS phone number route locally through provider network servicing both the subscriber's TD and the third party TD. Accordingly, the SLS provider may be positioned to minimize the charges it imposes on the SLS subscriber for the call between the SLS platform and the third party TD because it may have issued and used a local SLS phone number for the SLS; and the third party may be positioned to minimize the charges imposed on it by its primary service provider for the call between the SLS platform and the third party TD because the SLS phone number is a local number relative to it.

In certain specific embodiments the SLS involves a data communication. As compared to the embodiment described above, although the third party TD does not incur a long-distance or roaming fee for calling the SLS phone number, because the SLS phone number is a local phone number relative to the third party TD, the SLS subscriber may incur a roaming fee for the call between the subscriber TD and the SLS platform when using the voice channel of a telecommunications network. Consequently, the primary service provider of the SLS subscriber may exact a roaming charge (i.e., generate an invoice or a bill) for the call between the subscriber TD 110 to the SLS platform.

Accordingly, in some exemplary embodiments of the present invention involving a data connection for implementing the SLS, the exemplary method may include an SLS module configured to access a data communication. The call between the subscriber TD and the SLS platform for the SLS may be over a data channel of the telecommunications network, as would be understood by one of ordinary skill in the art. It is envisioned that (1) billing and/or reporting a call between the subscriber TD and the SLS platform by the SLS subscriber's primary service provider supplying the primary phone number of the subscriber TD 110 may be avoided; (2) because billing and/or reporting by the SLS subscriber's primary service provider is avoided regarding a call between the subscriber TD and the SLS platform, the subscriber may not see and be confused by a call listed on his primary phone number invoice as being placed to an otherwise hidden relationship number instead of to the recognizable third party number he actually dialed; (3) any charges imposed by the SLS subscriber's primary service provider may be limited to roaming data plan charges; (4) the SLS provider may be positioned to minimize the charges it imposes on the SLS subscriber for the call between the SLS platform and the third party TD because it may have issued and used a local SLS phone number for the SLS; and (5) the third party may be positioned to minimize the charges imposed on it by its primary service provider for the call between the SLS platform and the third party TD because the SLS phone number is a local number relative to it.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a block diagram illustrating an exemplary environment suitable for various embodiments of a system and method for providing a second line service to a subscriber using a TD.

FIG. 2 is a diagram of an exemplary computer architecture for the system of FIG. 1.

FIGS. 3A-3B illustrate exemplary data tables that may be leveraged by a redirection module of an SLS platform and an SLS module of a subscriber TD to provide a second line service to a user of the subscriber TD.

FIGS. 4A-4D collectively illustrate an exemplary method 400 for implementing an SLS call between a third party TD that is situated inside of the locality serviced by its primary service provider network and a TD associated with an SLS subscriber that is situated outside of the locality serviced by its primary service provider network.

FIGS. 5A-5D collectively illustrate an exemplary method 500 for implementing an SLS call between a third party TD that is situated inside of the locality serviced by its primary service provider network and a TD associated with an SLS subscriber that is situated outside of the locality serviced by its primary service provider network, using a data communication for the SLS.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the terms “application” and “app” may also include files having executable content, such as: object code, scripts, byte code, markup language files, and patches. In addition, an “application” referred to herein, may also include files that are not executable in nature, such as documents that may need to be opened or other data files that need to be accessed. Further, an “application” may be a complete program, a module, a routine, a library function, a driver, etc.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets, e.g., data from one component interacting with another component in a local system, distributed system, and/or across a network such as the Internet with other systems by way of the signal).

In this description, the terms “telecommunications device,” “communication device,” “wireless device,” “wireless telephone,” “wireless communication device” and “wireless handset” are used interchangeably. With the advent of third generation (“3G”) and fourth generation (“4G”) wireless technology, greater bandwidth availability has enabled more portable computing devices with a greater variety of wireless capabilities. Therefore, a telecommunications device (“TD”) may include a cellular telephone, a pager, a PDA, a smartphone, a navigation device, a tablet personal computer (“PC”), or a hand-held computer with a wireless connection or link.

In this description, the terms “call” and “communication,” in their noun forms, envision any data transmission routed across a network from one device to another including, but not limited to, a voice transmission, a text message, a video message, a page, a data transmission, etc.

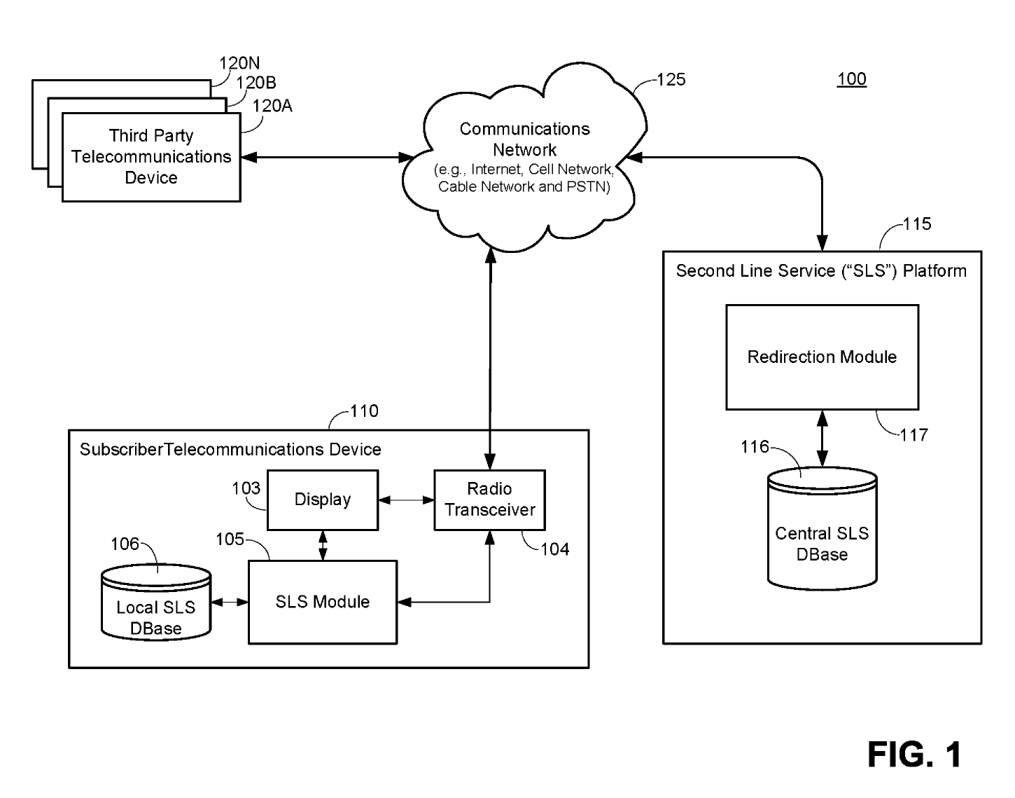

Referring to FIG. 1, depicted is a high level diagram illustrating exemplary components of a system 100 for providing an SLS to a subscriber TD 110. Subscriber TD 110 is also associated with a primary phone number assigned to it by the subscriber's home mobile service provider (“primary service provider”) as is understood by one of ordinary skill in the art. A subscriber to an SLS offered through exemplary system 100 may receive calls at subscriber TD 110 that were initially directed to either the primary phone number provided by the primary service provider or the secondary phone number (“SLS phone number”) provided, serviced and or facilitated by the SLS platform 115. Notably, depending on the particular embodiment, the primary service provider and the SLS platform, i.e., the second line service provider, may be the same provider or different providers. In embodiments where the primary service provider and the second line service provider are different providers, the SLS subscriber may receive separate billing records from each provider. However, it is envisioned that certain embodiments where the primary service provider and the second line service provider are not one and the same may take advantage of session initiated protocols (“SIP”) to simplify billing records for the user.

In general, any call directed to either of the primary phone number or the SLS phone number are transmitted from a third party TD 120 to the subscriber TD 110 by way of communications network 125. Notably, communications network 125 envisions any and all networks for transmitting and terminating communications between TDs such as, but not limited to, cellular networks, PSTNs, cable networks and the Internet. Methods for effecting the transmission of data across communications network 125 from one device to another, including call setups, terminations and the like are understood by those of ordinary skill in the art of data transmission and may include the use of protocols and standards such as, but not limited to, signaling system seven (“SS7”) protocol suite, SIP, customized applications for mobile networks enhanced logic (“CAMEL”) or CAMEL Application Part (“CAP”), remote operations service element (“ROSE”), Voice Over IP (“VOIP”), etc. Notably, while the use of any particular protocol or communications standard may be a novel aspect of a particular embodiment of the systems and methods, it will be understood that the scope of the systems and methods disclosed herein is not limited to the use of any particular protocol or combination of protocols.

A call made from a third party TD 120 to the primary number associated with subscriber TD 110 is transmitted across communications network 125 and routed to subscriber TD 110, as is understood in the art. The radio transceiver 104, if the TD 110 is a portable and wireless device, enables the receipt and transmission of signals to and from subscriber TD 110. The call signal may include the calling line identification (“CLID”), i.e., the phone number being used by and associated with third party TD 120 for the call, such that when the call is received at subscriber TD 110 the CLID may be displayed for the benefit of the SLS subscriber on display component 103.

Notably, although the exemplary embodiments described in the present disclosure use the CLID as an example of data that may be displayed for the benefit of the user of a subscriber TD 110, it will be understood that any data associated with the third party TD 120, subscriber TD 110, SLS platform 115 or the like may be rendered for the benefit of the user of the system 100 and, as such, only describing that the CLID is displayed will not limit the scope of what is envisioned by the disclosure. Moreover, it is envisioned that any data uniquely associated with a call to a primary number or an SLS phone number may be displayed for the benefit of a SLS subscriber to the system 100.

Returning to the FIG. 1 illustration, a call made from a third party TD 120 to an SLS phone number associated with subscriber TD 110 is transmitted across communications network 125. As one of ordinary skill in the art will understand, the communications network 125 routes the call based on the dialed SLS phone number and routes the call to SLS platform 115. This is the first leg of the SLS. SLS platform 115 thus effectively intercepts the call, determines that the call was intended for subscriber TD 110 and then takes actions such that the call can be terminated at the subscriber TD 110. This is the second leg of the SLS. In this way, while a call directed to a primary number associated with subscriber TD 110 is routed directly to subscriber TD 110, a call directed to a second line number associated with subscriber TD 110 is route to SLS platform 115 instead.

Once the call is received at SLS platform 115, a query of central SLS database 116 by redirection module 117 determines that the call from third party TD 120 was meant for the second line number associated with subscriber TD 110. Once the determination is made, redirection module 117 processes the call and performs additional network functions such that the call is made available for termination at subscriber TD 110 through its SLS.

Because the call may include data identifying it as a call to the SLS phone number associated with subscriber TD 110, SLS module 105 intercepts the incoming call, or otherwise injects itself into the call processing activity for the call, and then leverages data stored in local SLS database 106 to render it in such a way that subscriber TD 110 processes the call as an SLS call as opposed to a call directed at its primary phone number. The SLS module 105 is designed to work with radio transceiver 104 and any stored or retrievable content in local SLS database 106 to terminate a call to a SLS phone number, render associated data and provide services uniquely associated with the SLS phone number such as, but not limited to, dedicated voicemail, ringtones, caller ID, automated responses, etc.

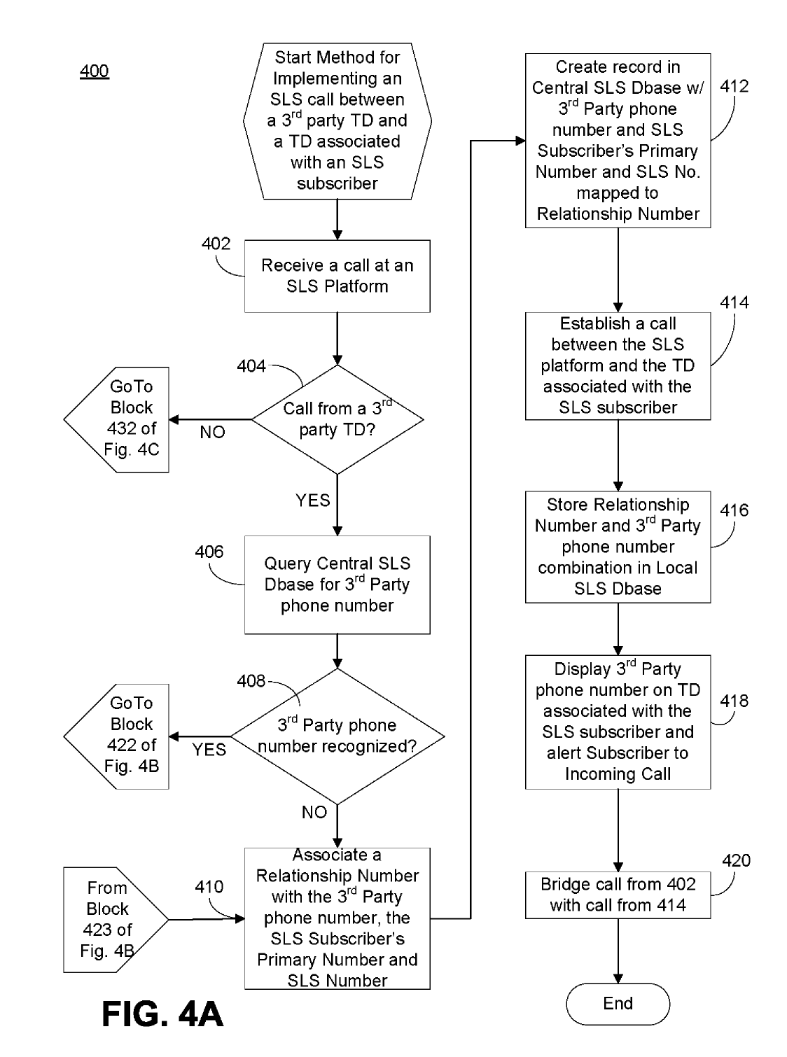

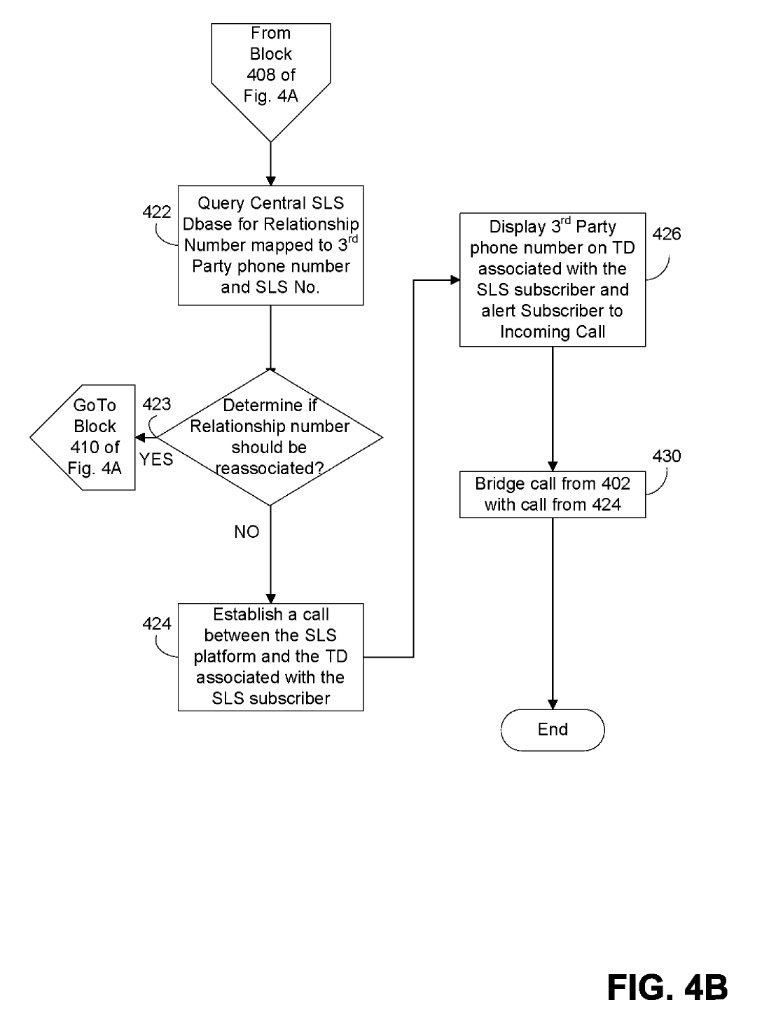

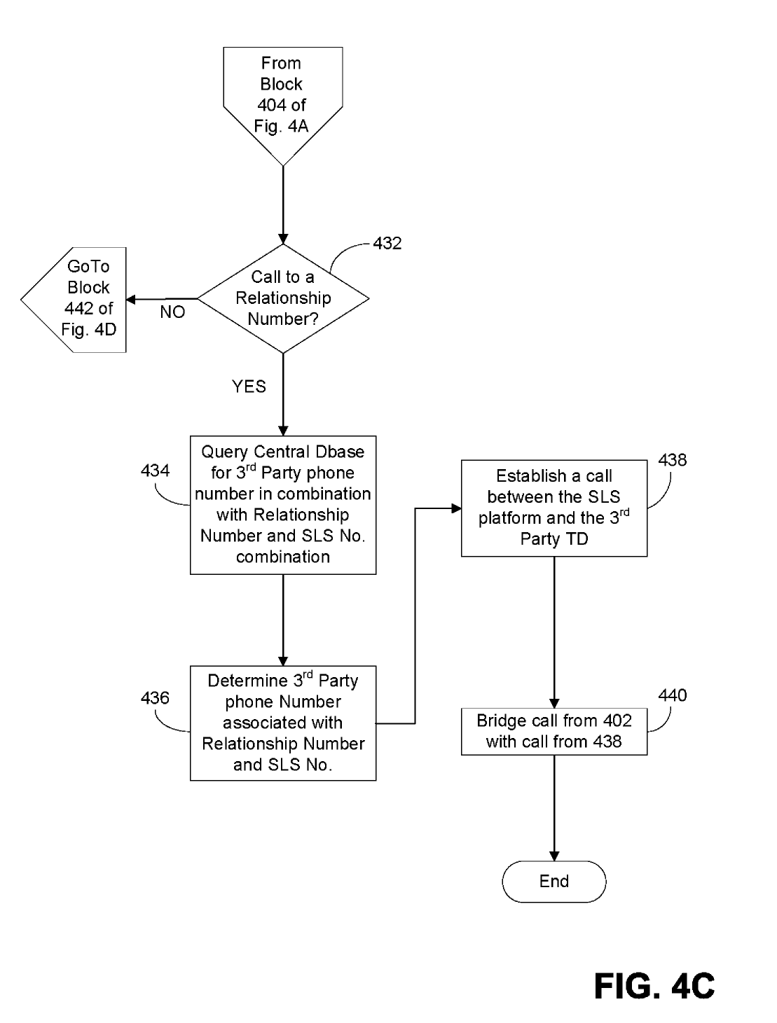

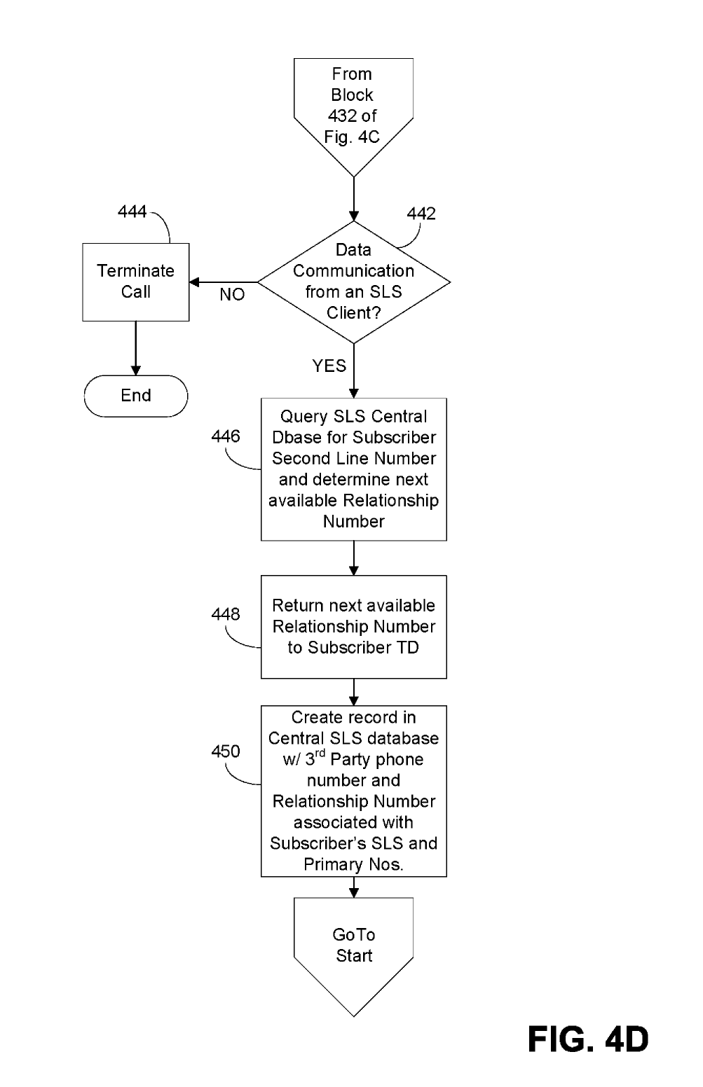

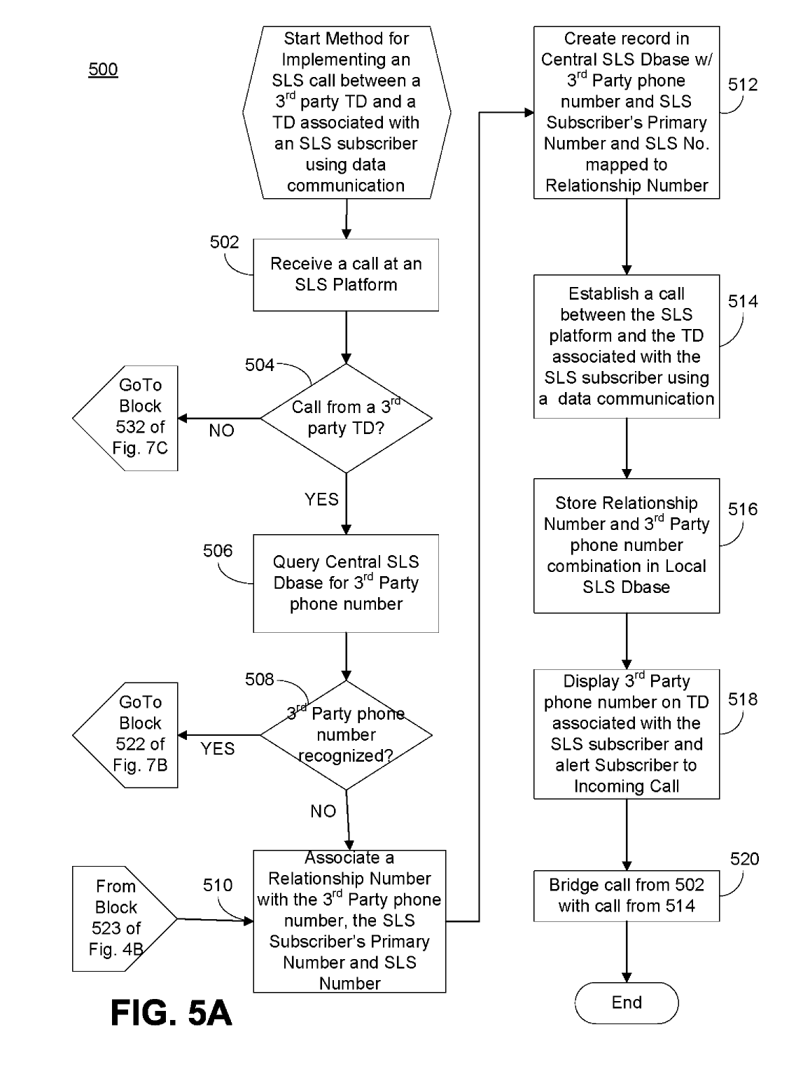

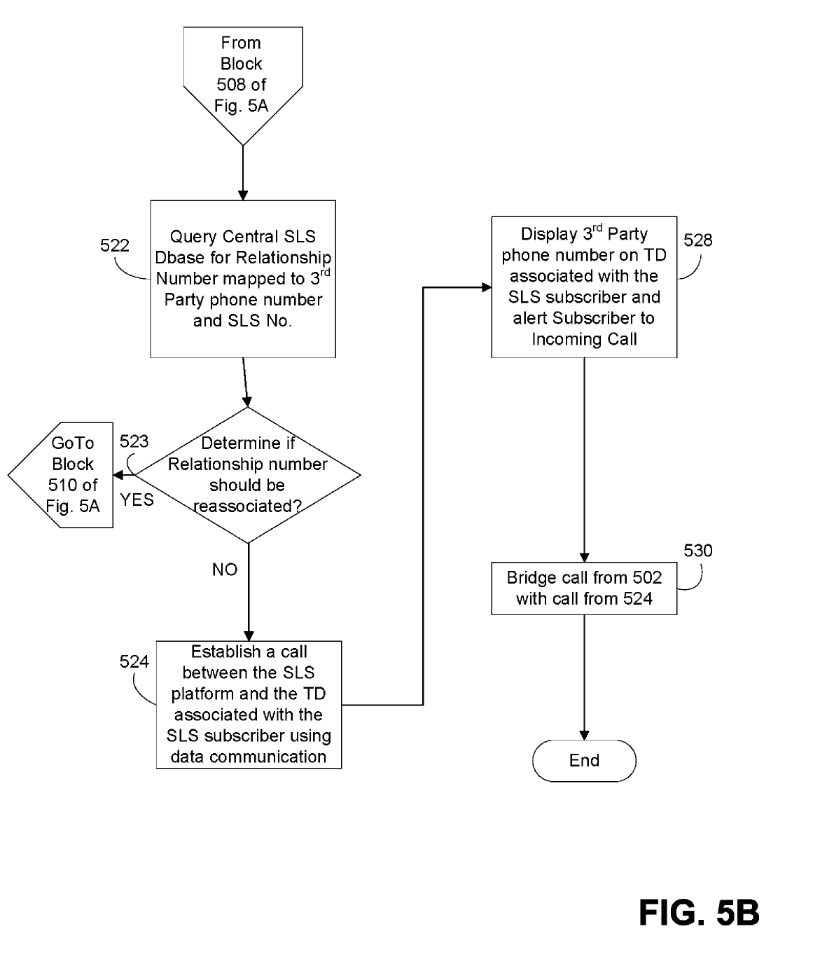

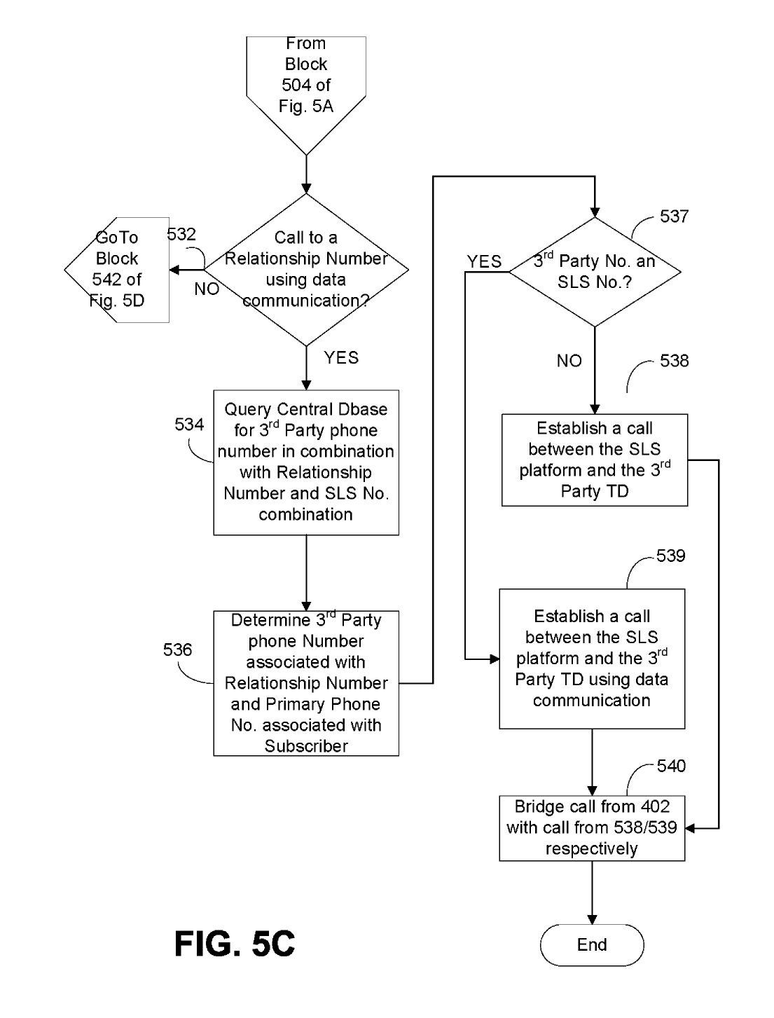

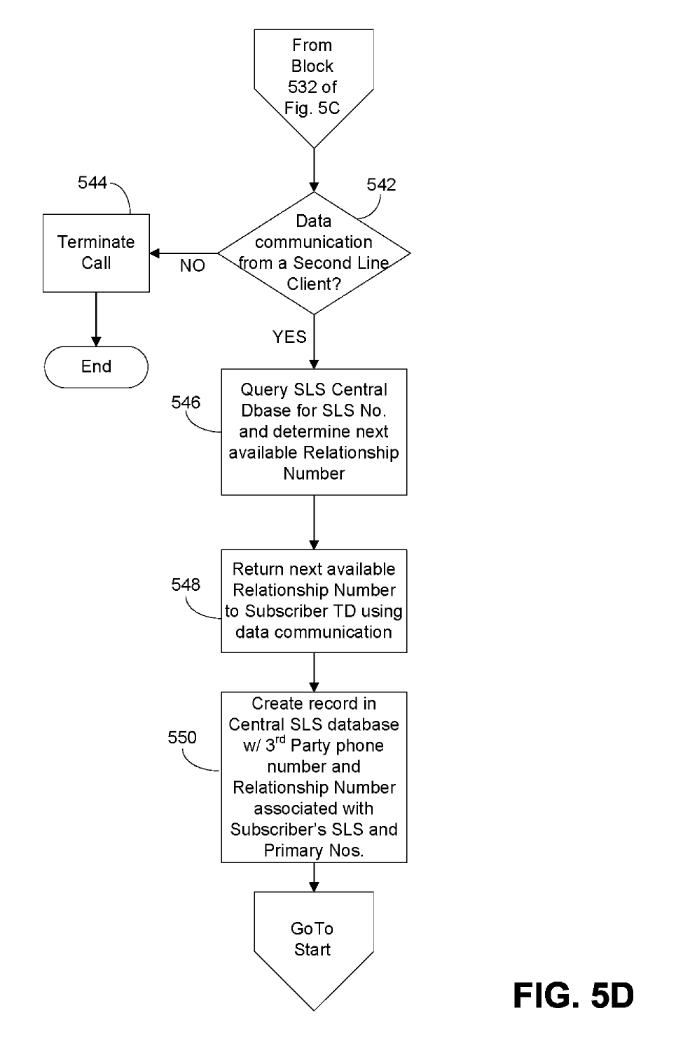

A more detailed description of the exemplary method, including exemplary methods for receiving a call from a third party TD 120 and making a call to a third party TD 120 by way of the SLS platform 115 will be described below relative to FIGS. 4-5.

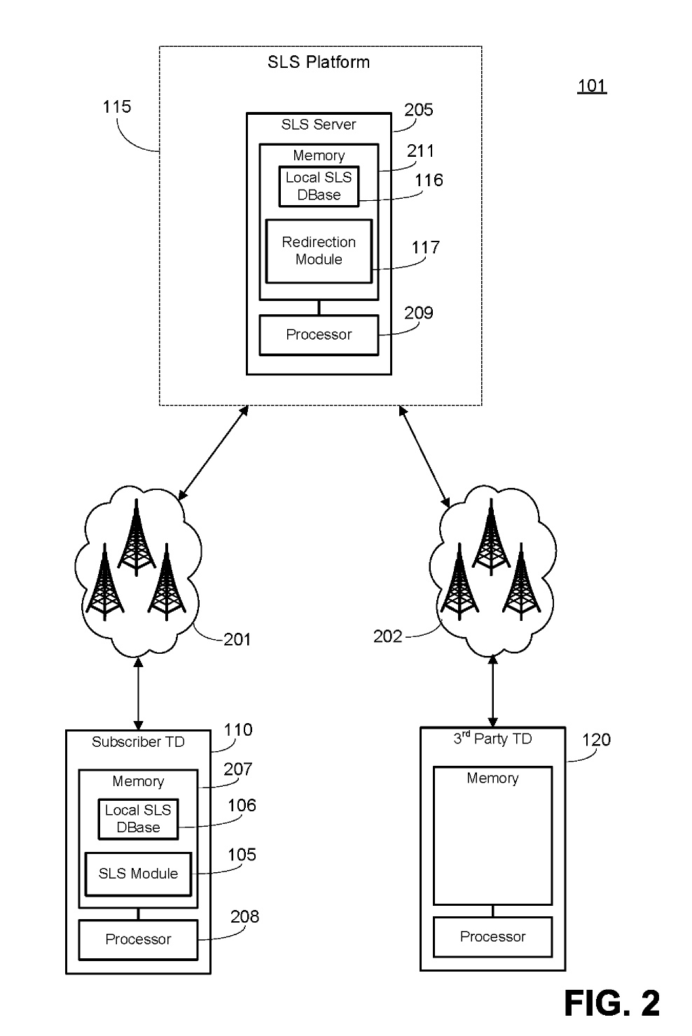

Referring to FIG. 2, a diagram of exemplary network architecture 101 for the system 100 of FIG. 1 is depicted. The exemplary network architecture 101 may include a subscriber TD 110 and a third party TD 120. Notably, although the third party TD 120 is not illustrated to suggest that it is equipped with SLS capability, it is envisioned that in some embodiments both the subscriber TD 110 and the third party TD 120 may be SLS enabled.

As shown in the FIG. 2 illustration, an SLS platform 115 may be connected to the subscriber TD 110 via a first provider network 201 and to the third party TD 120 via a second provider network 202, although it is envisioned that TDs 110 and 120 may be associated with a common service provider. One of ordinary skill in the art would recognize that communications network 125 from FIG. 1 can be comprised of smaller networks like first provider network 201 and second provider network 202.

It is envisioned that the first provider network 201 and the second provider network 202 can be the same network. Additionally, it is envisioned that the first provider network 201 and the second provider network can be operated, serviced, owned, etc., by the same or different service provider(s), and it is envisioned that either, or both, service providers respectively associated with provider networks 201 or 202 may function as both a primary service provider and/or an SLS provider for a given subscriber TD 110 or third party TD 120. Furthermore, it is envisioned that either or both of subscriber TD 110 and third party TD 120 may be associated with a primary service provider and a separate SLS provider.

Notably, depending on the particular embodiment, if subscriber TD 110 is situated outside of the locality serviced by its primary service provider network then the first provider network 201 may be a secondary service provider network that is servicing the new locality. The same is true for third party TD 120. Both of these “traveling” or “roaming” circumstances, and their associated systems and methods within the network architecture, are understood by those of ordinary skill in the art.

For exemplary purposes, the subscriber TD 110 is depicted as being SLS enabled and the third party TD 120 is depicted as not having a second line service associated with it. In the FIG. 2 illustration, it can be seen that the SLS platform 115 may include an SLS server 205 configured to receive calls directed to and from an SLS phone number associated with subscriber TD 110. Moreover, the subscriber TD 110 is depicted as being situated outside of the locality serviced by its primary service provider network and the third party TD 120 is depicted as situated inside of the locality serviced by its primary service provider network. Consequently, the first provider network 201 is depicted as a secondary service provider network for subscribers TD 110 while the second provider network 202 is depicted as a primary service provider network for TD 120. Finally, despite the different functions played by first provider network 201 and second provider network 202 relative to subscriber TD 110 and third party TD 120, first provider network 201 and the second provider network 202 are the same network in FIG. 2. Despite what is depicted for exemplary purposes, other combinations of primary and secondary service provider networks connecting SLS platform 115 to subscriber TD 110 and third party TD 120 are envisioned.

As illustrated in FIG. 2, the SLS server 205 includes a processor 209 and a memory 211 coupled to the processor 209. The memory 211 may include instructions for executing one or more of the method steps described herein. Further, the processor 209 and the memory 211 may serve as a means for executing one or more of the method steps described herein. As indicated, the memory 211 may also include a redirection module 117 and a central SLS database 116. Notably, it should be understood that the term server 205 may refer to a single server system or multiple systems or multiple servers. One of ordinary skill in the art will appreciate that the various server arrangements may be selected depending upon computer architecture design constraints and without departing from the scope of the invention.

As further illustrated in FIG. 2, the subscriber TD 110 may include a processor 208 and a memory 207 coupled to the processor 208. The memory 207 may include instructions for executing one or more of the method steps described herein. Further, the processor 208 and the memory 207 may serve as a means for executing one or more of the method steps described herein. As indicated, the memory 207 may also include an SLS module 105 and a local SLS database 106.

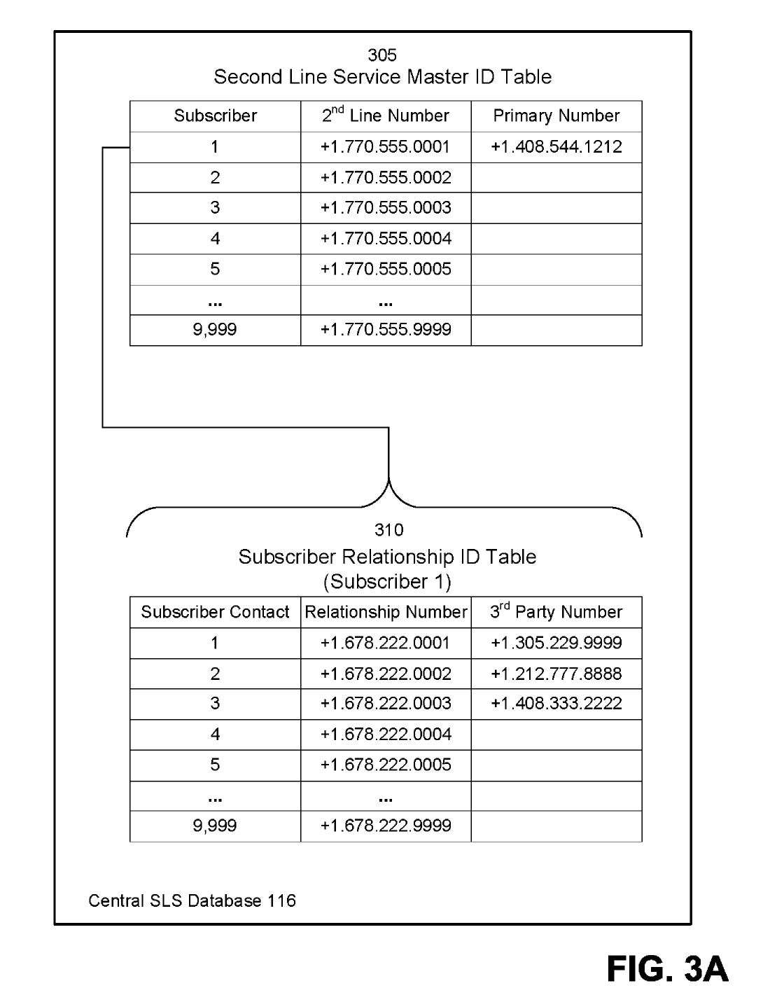

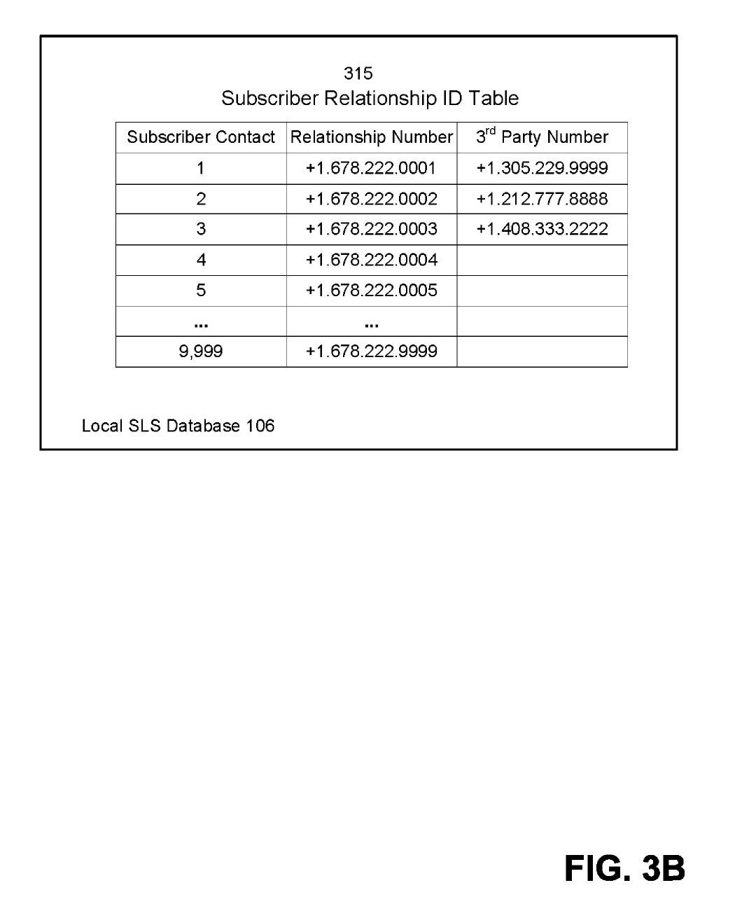

An illustrative embodiment of the method for providing an SLS to an SLS subscriber that is situated outside of the locality serviced by its primary service provider network will now be described in the context of the system and network architecture described in FIGS. 1-2 and the exemplary data tables reflected in FIGS. 3A-3B. As previously stated, FIG. 1 illustrates a call made from a third party TD 120 to an SLS phone number associated with subscriber TD 110. As one of ordinary skill in the art will recall, the communications network 125 routes the call based on the called number (the SLS phone number associated with the SLS subscriber). Ultimately, communications network 125 routes the call to SLS platform 115. SLS platform 115 effectively intercepts the call, determines that the call was intended for subscriber TD 110 and then takes actions using “relationship numbers” such that the call can be terminated at the subscriber TD 110. Consequently, this illustrative embodiment of the method involves leveraging two sets of intermediate phone numbers, one set of intermediate phone numbers for one leg of the SLS and the other for the second leg of the SLS, such that calls directed to subscriber TD 110 ultimately terminate at TD 110 using the SLS.

Referring to FIGS. 3A-3B, illustrated are exemplary data tables that may be leveraged by a redirection module 117 of an SLS platform 115 and an SLS module 105 of a subscriber TD 110 to provide a second line service to a user of subscriber TD 110. The Second Line Service Master ID Table 305 and Subscriber Relationship ID Table 310 of FIG. 3A are stored in a central SLS database 116 while the exemplary Subscriber Relationship ID Table 315 of FIG. 3B are stored in a local SLS database 106. As such, this illustrative embodiment involves leveraging two sets of intermediate phone numbers, the phone numbers related to the Second Line Service Master ID Table 305 and the phone numbers related to the Subscriber Relationship ID Tables.

With regard to the leveraging of the first set of intermediate phone numbers, specifically the phone numbers related to the Second Line Service Master ID Table 305, once the call reaches the SLS platform 115, an application running on redirection module 117 makes a translation to complete this first leg of the SLS. The SLS platform 115 maintains a master list of SLS phone numbers that are in service. In some embodiments, the SLS provider may be the owner, lessee, or assignee, etc. of these SLS phone numbers.

In the communications network 125, these SLS phone numbers route to the SLS platform 115, i.e., the SLS platform may be communicatively coupled with communications network 125, and any of its component networks like first provider network 201 or second provider network 202, such that a call directed at the SLS phone number is ultimately routed to the SLS platform. However, one of ordinary skill in the art will recognize that, depending on which provider network the SLS phone number is associated, a call directed at/directed from the SLS phone number is usually routed through its associated provider network before terminating at the SLS platform. For example, in FIG. 2, if the SLS phone number is associated with first provider network 201, then any call direct at/directed from the SLS phone number is routed through first provider network 201 regardless of the SLS phone number being owned, lease, or assigned, etc. by a separate SLS provider.

The SLS provider that manages the SLS platform 115 essentially has a group of SLS phone numbers in inventory, and the SLS provider assigns the SLS phone numbers to subscribers of the SLS. Regarding the SLS provider's inventory of SLS phone numbers, one of ordinary skill in the art will recognize that the SLS phone numbers may be random and generally unrelated to each other, i.e., although the exemplary SLS phone numbers depicted in the FIG. 3A Second Line Service Master ID Table are sequential, it is envisioned that such is not the case in all embodiments.

Moreover, one of ordinary skill in the art will recognize that, although the exemplary SLS phone numbers depicted in the FIG. 3A Second Line Service Master ID Table 305 include a specific country code, area code, and seven digit directory number, it is envisioned that any country code, area code and directory number system known to those skilled in the art is included within the scope of this disclosure. Additionally, it is envisioned that the SLS provider can maintain a large and diverse inventory of SLS phone numbers; each being associated with its respective provider network and, consequently, each routing through its associated provider network before terminating at the SLS platform 115.

Referring back to FIGS. 3A-3B and the Second Line Service Master ID Table 305, the example Subscriber #1, which, for exemplary purposes, is situated outside of the locality serviced by its primary service provider network, has been issued SLS phone number 1.770.555.0001. Other SLS subscribers in different situations and with different circumstances are within the scope of this disclosure. For exemplary purposes, the issued SLS phone number 1.770.555.0001 is associated with the provider network servicing the present locality of the SLS subscriber.

In FIG. 2, the provider network servicing the present locality of Subscriber #1, i.e., Subscriber #1's secondary service provider network, is depicted as the first provider network 201, which, although depicted as separate from, is the same network as second provider network 202 (as explained in detail above). As such, Subscriber #1 may choose to give out its SLS phone number to any of its contacts, especially those contacts that would make calls to or receive calls from the Subscriber #1 using a TD whose primary service provider is first provider network 201/second provider network 202. In FIG. 2, an example of a contact that would make calls to or receive calls from the Subscriber #1 using a TD whose primary service provider is the first provider network 201/second provider network 202 is third party TD 120.

With regard to the leveraging of the second set of intermediate phone numbers, specifically the phone numbers related to the Subscriber Relationship ID Tables, for each SLS subscriber a Subscriber Relationship ID Table 310 is also maintained. Referring to the Subscriber Relationship ID Table 310, the SLS provider has another list of dialable phone numbers, i.e., relationship numbers, which are maintained. These relationship numbers are essentially “hidden numbers” that are used to make the second leg of the call between the subscriber TD 110 and the SLS platform 115.

In some embodiments, the SLS provider may be the owner, lessee, or assignee, etc. of these relationship numbers. Like the SLS phone numbers, one of ordinary skill in the art will recognize that, depending on which provider network the relationship numbers are associated, a call direct at/directed from the relationship numbers are usually also routed through their associated provider network. For example, in FIG. 2, if the relationship numbers are associated with first provider network 201/second provider network 202, then any call direct at/directed from the relationship numbers is routed through first provider network 201/second provider network 202 regardless of the relationship number being owned, lease, or assigned, etc. by an SLS provider.

Concerning the Subscriber Relationship ID Table 310, one of ordinary skill in the art will understand that certain embodiments may not formally distinguish one SLS subscriber's records from that of another via individual subscriber relationship ID tables. Rather, as is understood in the art of database management and query, a more general relational database including records associated with multiple SLS subscribers may be used to map SLS subscriber number and third party number combinations to given relationship numbers. As such, it will be understood by one of ordinary skill in the art that the description in this disclosure of exemplary embodiments that include individual subscriber relationship ID tables are offered for illustrative purposes only and will not limit the scope of the disclosure.

Additionally, concerning the use of relationship numbers, it is envisioned that certain relationship numbers may be used for a plurality of SLS phone number and third party number combinations, i.e., in certain embodiments a given relationship number may not be unique to a given subscriber phone number and third party phone number combination. For example, in an illustrative embodiment, SLS subscribers D, E, F and G, may all have database records that map relationship number X to third party numbers J, K, L and E, respectively. Notably, in this exemplary scenario, the subscriber phone number and third party number combination G:E is meant to envision a case where G has a calling relationship with E. In such case, although E is a subscriber to the SLS it may also be treated as a third party caller relative to SLS subscriber G. To carry the example further, if G has a relationship with E, E also has one with G. However, the E:G combination may or may not use a different relationship number, such as Y.

Additionally, it is envisioned that in certain embodiments a relationship number may be used for purposes other than to map a third party calling number in Subscriber Relationship ID Table 310. For example, a given relationship number may be used by the SLS platform 115 to alert the SLS Module 105 that a call has been received from an unknown caller with a blocked CLID. Or, as another non-limiting example, a given relationship may be used by the SLS platform 115 to alert the SLS Module 105 that a voice message has been deposited for the SLS subscriber.

Like the SLS phone numbers, the SLS provider essentially has a group of relationship numbers in inventory, and the SLS provider assigns the relationship numbers as described above, and as described in greater detail below. Regarding the SLS provider's inventory of relationship numbers, one of ordinary skill in the art will recognize that the relationship numbers may be random and generally unrelated to each other, i.e., although the exemplary relationship numbers depicted in the FIG. 3A-3B Subscriber Relationship ID Tables are sequential, it is envisioned that such is not the case in all embodiments.

Moreover, one of ordinary skill in the art will recognize that, although the exemplary relationship numbers depicted in the FIG. 3A-3B Subscriber Relationship ID Tables include a specific country code, area code, and seven digit directory number, it is envisioned that any country code, area code and directory number system known to those skilled in the art is included within the scope of this disclosure. Additionally, it is envisioned that the SLS provider can maintain a large and diverse inventory of relationship numbers; each being associated with its respective provider network and, consequently, each routing through its associated provider network when leveraged by the SLS.

Referring again to FIGS. 3A-3B and the Subscriber Relationship ID Tables, the example third parties with numbers 1.305.229.9999, 1.212.777.8888 and 1.408.333.2222, which, for exemplary purposes, are situated inside of the locality serviced by their primary service provider network, have been issued relationship numbers 1.678.222.0001, 1.678.222.0002 and 1.678.222.0003. Other third parties in different situations and with different circumstances are within the scope of this disclosure.

As mentioned above, the relationship numbers are “behind the scenes” numbers that are hidden from the SLS subscriber and any third party calling the SLS subscriber through the SLS. This is accomplished by an app running on SLS module 105 residing on subscriber TD 110. In the illustrative embodiment, SLS platform 115 has effectively intercepted the first leg of the SLS and determined that the call was intended for subscriber TD 110 (this was described above). As will be described in greater detail below, SLS platform 115 takes an action that involves the relationship number such that the call can be terminated at the subscriber TD 110. Essentially, by leveraging the relationship number, an SLS provider may insert itself into the middle of a call between a third party TD 120 and a subscriber TD 110.

Returning to the FIGS. 3A-3B and the illustrative embodiment, Subscriber #1 associated with subscriber TD 110 already has mobile phone service via its primary service provider using mobile phone number 1.408.544.1212. Subscriber #1 plans to be or presently is situated outside of the locality serviced by its primary service provider network so Subscriber #1 subscribes to an SLS provided by way of SLS platform 115 and is assigned SLS phone number 1.770.555.0001. Although other SLS subscribers in different situations and with different circumstances are within the scope of this disclosure, for exemplary purposes, the issued SLS phone number 1.770.555.0001 is associated with first provider network 201/second provider network 202. As such, Subscriber #1 may choose to give out its SLS phone number to any of its contacts, especially those contacts that would make calls to or receive calls from the SLS using a TD associated with first provider network 201/second provider network 202.

A third party, identified in Subscriber Relationship ID Table 310 of FIG. 3A as being Subscriber Contact #1, is associated with a third party TD 120A having a primary phone number 1.305.229.9999. Notably, although the primary phone number 1.305.229.9999 associated with third party TD 120 is described herein as a primary phone number, it will be understood that it may, in fact, be a second line number in embodiments where the third party is also an SLS subscriber.

The third party uses TD 120 to place a call to the Subscriber #1's SLS phone number 1.770.555.0001. As described above, the call is routed to the SLS platform 115. The SLS platform 115 accepts the call and determines that the call is for SLS phone number 1.770.555.0001 and that 1.770.555.0001 requires a “relationship” set up for 1.305.229.9999. It is envision that setting up a relationship can takes into consideration Subscriber #1 being presently situated outside of the locality serviced by its primary service provider network and in the same locality serviced by the third party's primary service provider. This would be the case regardless of whether a “relationship” has or has not been previously established between the two parties. For purposes of this exemplary embodiment, Subscriber #1 has only recently subscribed to the SLS and Subscriber Relationship ID Table 310 does not yet contain any records, i.e., the third party associated with TD 120 is the first to place a call to the SLS phone number of Subscriber #1; additionally, subscriber TD 110 and third party TD 120 are presently on the same network represented by first provider network 201/second provider network 202 (first provider network 201/second provider network 202 functioning as a primary service provider network for third party TD 120 because it is in its home network; first provider network 201/second provider network 202 functioning as a secondary service provider network for subscriber TD 110 because it is roaming in a foreign network).

It is envisioned by this disclosure that the SLS provider, the SLS platform 115, etc., can determine the location of an SLS subscriber, when establishing relationship number, through any system or method known to those of ordinary skill in the art. Non-limiting examples of these methods and system include GPS location service on the TD, access to the geographic information of the network, direct communication with the SLS subscriber as to their immediate location, etc.

Returning to the illustrative embodiment, based on the subscriber TD 110 and third party TD 120 being presently on first provider network 201/second provider network 202, the SLS platform 115 creates the following relationship in Subscriber Relationship ID Table 310: When 1.770.555.0001 receives (or places) a call from/to 1.305.229.9999, the interaction with the subscriber TD 110 (having primary phone number 1.408.544.1212) will use dialable relationship number 1.678.222.0001. This relationship number was selected because it is a phone number associated with the provider network servicing the present locality of the SLS subscriber; specifically, first provider network 201/second provider network 202. Notably, it is envisioned that a given relationship number, such as relationship number 1.678.222.0001 in the present example, may be used as a relationship number for many different SLS subscribers as it is the combination of the SLS subscriber's primary number and/or the SLS phone number and the relationship number that map to the external number (in this case, 1.305.229.2999).

Now that the relationship number 1.678.222.0001 has been established in connection with Subscriber #1 and the calling third party, the SLS platform 115 may proceed to establish the second leg of the SLS—the call from the SLS platform 115 to the subscribers TD 110. The SLS platform 115 places the call to the subscriber TD 110. It is known to those with ordinary skill in the art that methods for establishing this second leg of the SLS include the use of protocols and standards such as, but not limited to, SS7 protocol suite, SIP, CAMEL or CAP, ROSE, VOIP, etc. It is of course possible for the SLS platform 115 to direct the call to the primary number 1.408.544.1212 of the subscriber TD 110 using standard voice channels; however, this may not result in avoidance of “roaming charges” by Subscriber #1 as are understood by those of ordinary skill in the art.

Returning to the illustrative embodiment, the CLID field for the call placed from SLS platform 115 to subscriber TD 110 may contain a specially encoded message for the SLS phone app running on SLS module 105. In some embodiments, this CLID field may contain the relationship number established by the SLS platform 115 (in this example, 1.678.222.0001) and the actual primary number of the calling third party (in this example, 1.305.229.9999), separated by a dialable separator such as a “star” character. In other embodiments, this CLID field may be populated with “unknown caller” or the like in the event that the relationship number is a new number assigned by the SLS platform 115 and not yet recognized by the SLS phone app (more details regarding such an embodiment is described below relative to FIGS. 4 and 5). Notably, it is envisioned that other embodiments may populate this CLID field, or provide other metadata, that serves to trigger recognition of the incoming call as a call directed to the SLS phone number of the SLS subscriber. As such, by describing the exemplary embodiment to populate this CLID field with a combination of the relationship number and the third party's actual phone number, the scope of the disclosure will not be limited.

Having recognized that the incoming call is from the SLS platform 115, the SLS module 105 stores the combination of the relationship number 1.678.222.0001 and the phone number being used by the third party 1.305.229.9999 in the local SLS database 106. To complete the exemplary call, the SLS module 105 may cause the actual phone number associated with the third party TD 120, 1.305.229.9999, to be rendered on display component 103 as an identification of the calling party and rings the phone. Once the Subscriber #1 answers, the SLS platform 115 connects the two legs of the SLS (leg 1 represented by third party TD 120A to SLS platform 115 and leg 2 represented by SLS platform 115 to subscriber TD 110) by methods known and understood by those of ordinary skill in the art of telecommunications. As non-limiting examples, the calls can be connected via a forward or a bridge, as well as other technologies known to those with ordinary skill in the art. Notably, it is envision by this disclosure that the call could be routed through the intermediate SLS platform 115 as a way of enabling the SLS between the third party TD 120 and the subscriber TD 110.

Notably, in the example, the combination of the relationship number 1.678.222.0001 and the phone number being used by the third party 1.305.229.9999 is now stored in the central SLS database 116 at SLS platform 115 and also in the local SLS database 106 in subscriber TD 110. As one of ordinary skill in the art will recognize, the importance of the relationship number is that it may also provide a mechanism by which the SLS platform 115 may intercept SLS calls originating from subscriber TD 110 (in much the same way as the SLS phone number provides a mechanism by which the SLS platform may intercept SLS calls originating from the third party TD 120).

Furthering the example, suppose Subscriber #1 desires to initiate a call to the third party associated with 1.305.229.9999 from its SLS phone number 1.770.555.0001. Because the third party associated with 1.305.229.9999 had previously placed a call to the SLS phone number 1.770.555.0001, the relationship combination that maps Subscriber #1's SLS phone number 1.770.555.0001 and the third party phone number 1.305.229.9999 to relationship number 1.678.222.0001 is already stored in both the central SLS database 116 at SLS Platform 115 and the local SLS database 106 in subscriber TD 110.

To place calls from its SLS phone number, Subscriber #1 uses the SLS phone app of SLS module 105 as his dialer, as a non-limiting example of one potential embodiment. In the SLS dialer (not depicted in the FIGs), Subscriber #1 dials the third party phone number 1.305.229.9999, which is reflected in the Private Relationship ID Tables 310 and 315 as being associated with his Contact #1. The SLS module 105 queries Subscriber Relationship ID Table 315 in local SLS database 106 and translates the dialed third party number 1.305.229.9999 to relationship number 1.678.222.0001. The SLS module 105 may indicate to the SLS subscriber via display 103 that it is calling 1.305.229.9999, but instead it calls the relationship number 1.678.222.0001. By calling the relationship number associated with Contact #1, the communications network 125 routes the call to the SLS platform 115 instead of directly to third party TD 120.

When the SLS platform 115 processes this first leg of the SLS, it may recognize that the calling number is the SLS subscriber's primary number 1.408.544.1212 (which is associated with the subscriber's SLS phone number 1.770.555.0001) and the called number is the relationship number 1.678.222.0001. Querying the Subscriber Relationship ID Table 310 in central SLS database 116, the redirection module 117 may apply the following logic: “when primary number 1.408.544.1212 calls relationship number 1.678.222.0001, it is actually SLS phone number 770.555.0001 calling 1.305.229.9999.” The SLS platform 115 may then follow that logic and complete the second leg of the SLS by calling the actual number 1.305.229.9999 associated with third party TD 120 using the SLS number 1.770.555.0001.

Notably, in completing the second leg of the SLS and connecting the two legs (in much the same way as described above for SLS calls originating from a third party), the SLS platform 115 may modify the CLID field displayed for the benefit of TD 120 to be something other than the SLS phone number 1.770.555.0001 from which the second leg of the SLS is made. As a non-limiting example, it is envisioned that the SLS platform 115 may modify the CLID field to be the primary number of subscriber TD 110.

As described above, it is envisioned that another SLS subscriber (for example, Subscriber #2 having SLS phone number 1.770.555.0002) could also initiate the first leg of an SLS call by using the relationship number 1.678.222.0001. In this situation, the SLS platform 115 would direct the second leg of the SLS to a different third party number associated with a contact of Subscriber #2. As is described above, the encoded third party phone number called by the SLS platform 115 for the second leg of the call is derived from the combination of the SLS phone number and the relationship number.

FIGS. 4A-4D collectively illustrate an exemplary method 400 for implementing an SLS call between a third party TD, such as third party TD 120 that is situated inside of the locality serviced by its primary service provider network, and a TD associated with an SLS subscriber, such as subscriber TD 110 that is situated outside of the locality serviced by its primary service provider network. The SLS phone number for subscriber TD 110 issued by the SLS provider is a phone number associated with the network servicing the present locality of the subscriber TD 110 (in FIG. 3, this network is represented by first provider network 201/second provider network 202; this is also the primary network of third party TD 120). As such, the SLS phone number is a local phone number relative to the primary phone number of third party TD 120 and any calls directed to or directed from the SLS phone number route through first provider network 201/second provider network 202.

Accordingly, for the SLS embodiment of method 400 it is envisioned that:
1) The SLS provider may be positioned to minimize the charges it imposes on the SLS subscriber for the call between the SLS platform 115 and the third party TD 120 because it may have issued and used a local SLS phone number for the SLS; and
2) The third party may be positioned to minimize the charges imposed on it by its primary service provider for the call between the SLS platform 115 and the third party TD 120 because the SLS phone number is a local number relative to it.

At block 402, a call is directed to and received by an SLS platform 115. Notably, the call is envisioned to be any communication over communications network 125 that is directed to SLS platform 115, regardless of whether such communication originates from a subscriber TD 110 or a third party TD 120. One of ordinary skill in the art will recognize that a communication may include the use of protocols and standards such as, but not limited to, SS7 protocol suite, SIP, CAMEL or CAP, ROSE, VOIP, etc.

Next, at decision block 404, the SLS platform 115 determines whether the call originated from a third party TD 120 directed to an SLS subscriber, i.e., whether a third party has dialed an SLS phone number associated with an active SLS subscriber. If the communication was not a call that originated from a third party TD 120, then the “no” branch is followed to block 432 of FIG. 4C. If the call did, in fact, originate from a third party TD 120, then the “yes” branch is followed to block 406. Notably, if a call is directed to the SLS platform 115, one of ordinary skill in the art will recognize that the communication was either a call to an SLS phone number (if dialed by a third party TD 120), a call to a relationship number (if originating from an SLS client of a subscriber TD 110), or a data communication originating from an SLS client of a subscriber TD 110 (not depicted in the figures).

At block 406, the SLS platform 115 queries central SLS database 116 for the phone number being used by third party TD 120 in association with the SLS phone number that caused the call to be routed to the SLS platform 115. Notably, because the SLS phone number is a local phone number relative to the third party TD 120, the third party does not incur a long-distance or roaming fee for calling the SLS phone number. If at decision block 408, the SLS platform 115 successfully queries the phone number being used by third party TD 120 and SLS phone number combination, then the “yes” branch is followed to block 422 of FIG. 4B. If the phone number being used by third party TD 120 and SLS phone number combination are not successfully queried, then the “no” branch is followed to block 410.

At block 410, the SLS platform 115 may associate a new relationship number with the phone number being used by third party TD 120 to make the call, the SLS subscriber's primary phone number and the subscriber's SLS phone number. It is envisioned that this associating may take into consideration subscriber TD 110 being presently situated outside of the locality serviced by its primary service provider network and in the same locality serviced by the third party TD 120's primary service provider. One of ordinary skill in the art will recognize that that the SLS provider, the SLS platform 115, etc. can determine the location of an SLS subscriber through a variety of system or methods. Non-limiting examples of these methods and system include GPS location service on the TD, access to the geographic information of the network, direct communication with the SLS subscriber as to their immediate location, etc.

At block 412, the central SLS database 116 is updated to include the newly created record—the phone number being used by third party TD 120 to make the call is listed as a contact of the SLS subscriber in the Subscriber Relationship ID Table 310. At block 414, a call is established between the SLS platform 115 and the subscriber TD 110. In some non-limiting embodiments of block 414, the SLS platform 115 initiates the call through the communication network 125's voice channel with the subscriber TD 110 by dialing its primary phone number from the relationship number of block 410. In other non-limiting embodiments of block 414, the subscriber's TD 110 initiates the call through the communication network 125's voice channel with the SLS platform 115 by dialing the relationship number of block 410 from the subscriber TD 110's primary phone number after receiving a data communication from the SLS platform 115 with information containing the relationship number of block 410 and instructions to initiate the call (again, one of ordinary skill in the art will recognize that a communication may include the use of protocols and standards such as, but not limited to, SS7 protocol suite, SIP, CAMEL or CAP, ROSE, VOIP, etc). In certain non-limiting embodiments of block 414, the SLS platform 115 may populate the CLID field of the call between it and the subscribers TD 110 with a combination of the newly assigned relationship number and the phone number being used by third party TD 120 to make the call.

At block 416, the local SLS database 106 updates to include the newly assigned relationship number in association with the phone number being used by third party TD 120 to make the call. At block 418, the phone number being used by third party TD 120 to make the call is displayed to the SLS subscriber and the SLS subscriber is alerted to the incoming call. Notably, it is envisioned that displaying the phone number being used by third party TD 120 to make the call may include rendering the CLID field itself, rendering a picture of the third party, rendering a name, etc. as is understood by those with ordinary skill in the art of graphical user displays and interfaces. At block 420, the call from block 402 is bridged with the call from block 414 resulting in an active call between third party TD 120 and subscriber TD 110. One of ordinary skill in the art will recognize that there are many systems and methods known and understood for bridging or connecting a plurality of separate calls (the legs of the SLS); consequently, this disclosure is not limited by the used example “bridged.”

It is envisioned that the steps taken at block 418 of the method 400 may differ in some embodiments. For instance, when a third party TD 120's call to an SLS phone number is received at the SLS platform 115, and the phone number being used by third party TD 120 to make the call is not yet associated with a relationship number, the SLS platform 115 may assign a next relationship number as described relative to blocks 410-412 then establish a call with the subscriber TD 110 as described in 414. The SLS module 105 of the subscriber TD 110, having no record of the new relationship number in its local database 106, may display the calling number as “unknown caller” on the display of the subscriber TD 110. At the same time, the SLS module 105 may establish a data connection over communications network 125 with the SLS platform 115 for the purpose of acquiring the third party calling number associated with the new relationship number. Once the phone number being used by third party TD 120 to make the call is acquired, the SLS module 105 may update the local database 106 and change the display from “unknown caller” to the phone number being used by third party TD 120 to make the call.

Turning now to FIG. 4B, if the “yes” branch is followed from decision block 408 of FIG. 4A, at block 422 the SLS platform 115 queries the central SLS database 116 for the relationship number that maps to the combination of the phone number being used by third party TD 120 and subscriber's SLS phone number. At block 423, the SLS platform 115 determines if it should modify the relationship number of block 422 based on the location of the subscriber TD 110. If at decision block 423 the SLS platform 115 determines that it should modify the relationship number of block 422 based on the location of the subscriber TD 110, then the “yes” branch is followed to block 410 of FIG. 4A. (Again, one of ordinary skill in the art will recognize that that the SLS provider, the SLS platform 115, etc. can determine the location of an SLS subscriber through a variety of system or methods. Non-limiting examples of these methods and system include GPS location service on the TD, access to the geographic information of the network, direct communication with the SLS subscriber as to their immediate location, etc.). If at decision block 423 the SLS platform 115 determines that it should not modify the relationship number of block 422 based on the location of the subscriber TD 110, then the “no” branch is followed to block 424.

At block 424, a call is established between the SLS platform 115 and the subscriber TD 110. In some non-limiting embodiments of block 424, the SLS platform 115 initiates the call through the communication network 125's voice channel with the subscriber TD 110 by dialing its primary phone number from the relationship number of block 422. In other non-limiting embodiments of block 414, the subscriber's TD 110 initiates the call through the communication network 125's voice channel with the SLS platform 115 by dialing the relationship number of block 422 from the subscriber TD 110's primary phone number after receiving a data communication from the SLS platform 115 with information containing the relationship number of block 422 and instructions to initiate the call. In certain non-limiting embodiments of block 414, the SLS platform 115 may populate the CLID field of the call between it and the subscribers TD 110 with a combination of the assigned relationship number and the phone number being used by third party TD 120 to make the call.

It is envisioned that in some embodiments of block 424 an SLS module 105 may recognize that an incoming call is from the SLS platform 115 by virtue of the call originating from a relationship number. At block 426, the phone number being used by third party TD 120 to make the call is displayed to the SLS subscriber and the SLS subscriber is alerted to the incoming call. Notably, it is envisioned that displaying the phone number being used by third party TD 120 to make the call may include rendering the CLID itself, rendering a picture of the third party, rendering a name, etc. as is understood by those with ordinary skill in the art of graphical user displays and interfaces. In certain non-limiting embodiments of block 426, the information populated by the SLS platform 115 in the CLID field of the call between SLS platform 115 and the subscribers TD 110 may cause the SLS module 105 to handle the call and display the associated third party CLID for the benefit of the subscriber.

At block 430, the call from block 402 is bridged with the call from block 424 resulting in an active call between third party TD 120 and subscriber TD 110. One of ordinary skill in the art will recognize that there are many systems and methods known and understood for bridging or connecting a plurality of separate calls (the legs of the SLS); consequently, this disclosure is not limited by the used example “bridged.” It is envisioned that, if the subscriber elects not to answer a call to the SLS phone number, the SLS module 105 in some non-limiting embodiments may use a voicemail service or message service in response to the unanswered call. That is, it is envisioned that an SLS service may provide features and services dedicated to the SLS subscriber and separate from similar features and services associated with the subscriber's primary number.

Turning now to FIG. 4C, if the “no” branch is followed from block 404 of FIG. 4A, at decision block 432 the SLS platform 115 determines if the call was directed to a relationship number. Notably, if the call is directed to a relationship number, then it must have originated from a subscriber TD 110. If the call was not directed to a relationship number, the “no” branch is followed to block 442 of FIG. 4D. If, however, the call was routed to the SLS platform 115 because it was directed to a relationship number then the “yes” branch is followed to block 434.

At block 434, the central SLS database 116 is queried for the third party TD 120's phone number in combination with the relationship number that was dialed by subscriber TD 110 that resulted in the call routing to the SLS platform 115 and the SLS phone number and the SLS subscriber's primary phone number. At block 436, the SLS platform 115 determines the third party TD 120's phone number with which the relationship number and the SLS subscriber's primary phone number combination is associated. At block 438, a call is established between the SLS platform 115 and the third party TD 120. In some non-limiting embodiments of block 438, the SLS platform 115 initiates the call through the communication network 125's voice channel with the third party TD 120 by dialing the third party TD 120's phone number determined in block 436. In some non-limiting embodiments of block 438, the SLS platform 115 may populate the CLID field of the call between it and the third party TD 120 with the SLS phone number of subscriber TD 110. In other non-limiting embodiments of block 438, the SLS platform 115 may populate the CLID field of the call between it and the third party TD 120 with the primary phone number of subscriber TD 110.

At block 440, the call from block 402 is bridged with the call from block 438 resulting in an active call between subscriber TD 110 and third party TD 120. One of ordinary skill in the art will recognize that there are many systems and methods known and understood for bridging or connecting a plurality of separate calls (the legs of the SLS); consequently, this disclosure is not limited by the used example “bridged.” It is envisioned that, if the third party elects not to answer a call to it from SLS, the SLS platform 115 in some non-limiting embodiments may continue the bridge even when the call from block 438 is routed to its voicemail service or message service.

Turning now to FIG. 4D, if the “no” branch is followed from block 432 of FIG. 4C, at decision block 442 the SLS platform 115 determines that the communication is a data communication over communications network 125 that originated from an SLS client of a subscriber TD 110. If not, then it is assumed that it was an errant communication and the “no” branch is followed to block 444 and the communication is disconnected. If the communication did originate from a SLS client, i.e., an SLS module 105 in a subscriber TD 110 associated with a subscriber to the SLS service, then the “yes” branch is followed to block 446. It is envisioned that the communication from an SLS client application to an SLS platform may be of any protocol suitable for communicating over communications network 125 including the use of protocols and standards such as, but not limited to, SS7 protocol suite, SIP, CAMEL or CAP, ROSE, VOIP, etc.

At block 446, it is deduced by the SLS platform 115 that the subscriber associated with the calling SLS client desires to use the SLS service to call third party TD 120's phone number with which no relationship number has been previously associated (such as would occur at block 410). The SLS module 105 has provided the request for the new relationship number, along with the third party number it desires to call, to the SLS platform 115 via the data communication. The central SLS database 116 is queried at block 446 to determine the next available relationship number for the subscriber's given SLS phone number.

The SLS platform 115 may associate a new relationship number with the subscriber's SLS phone number, the SLS subscriber's primary phone number and the third party TD 120's phone number. It is envisioned that this associating may take into consideration subscriber TD 110 being presently situated outside of the locality serviced by its primary service provider network and in the same locality serviced by the third party TD 120's primary service provider. One of ordinary skill in the art will recognize that that the SLS provider, the SLS platform 115, etc. can determine the location of an SLS subscriber through a variety of system or methods. Non-limiting examples of these methods and system include GPS location service on the TD, access to the geographic information of the network, direct communication with the SLS subscriber as to their immediate location, etc.

It is envisioned that the SLS module 105 may communicate with the SLS platform 115 in some embodiments to obtain a relationship number for a third party that has not previously been called via a session-based protocol such as, but not limited to, an unstructured supplementary services data (“USSD”) protocol. As is understood in the art of telecommunications protocols, a gateway such as a USSD gateway may be used to route messages from a signaling network to service applications and back. In this way, certain embodiments of an SLS module 105 may communicate with an SLS platform 115 to designate and acquire a relationship number to a third party who has not been called by the subscriber before via the SLS (or, for that matter, a third party who has not placed a call to the subscriber's SLS phone number before).

Moreover, USSD is offered herein for exemplary purposes and is not meant to limit the type of communications protocol that may be used by certain embodiments. For example, it is envisioned that short message service (“SMS”) protocol, multimedia messaging service (“MMS”) protocol, and/or other protocols may be used by some embodiments. It is envisioned that an IP-based interaction over the TD's data service may be used by some embodiments. As would be recognized by one of ordinary skill in the art, use of session based protocols or other communication protocols may minimize temporal delays in allocating and acquiring relationship numbers between an SLS module 105 and an SLS platform 115. In fact, it is anticipated that any mechanism that can be used to establish a communication path between the SLS module 105 and the SLS platform 115 for the purposes of supporting the SLS can be utilized. This may include any of the varieties of cellular data, WiFi, Bluetooth technologies, proprietary wireless or wired technologies, etc. Such channels can be used in setting up the relationship databases, sharing information between the SLS module 105 and the SLS platform 115, initiating voice communication establishment from the TD 110 to the SLS platform 115, the TD 110 requesting the SLS platform 115 to place a call to a third party TD 120, etc.

At block 448, the determined next available relationship number is returned to the SLS module 105 of the subscriber TD 110. At block 450, the central SLS database 116 is updated with the new relationship number. The new relationship number is now associated in the central SLS database 116 with the subscriber's SLS phone number, the SLS subscriber's primary phone number and the third party TD 120's phone number. Notably, after blocks 448 and/or 450, the method 400 may return to the start of method 400 at block 402 as the SLS module 105 of the subscriber TD 110 has acquired a new relationship number in association with a third party TD 120's phone number. Consequently, using the newly acquired relationship number may essentially start over the method 400 with the SLS platform 115 receiving the call. If so, the method 400 would follow to FIG. 4C where the call was recognized as the subscriber TD 110 having placed a call to the new relationship number.

Turning now to FIG. 5, an exemplary method 500 for implementing an SLS call between a third party TD, such as third party TD 120, that is situated inside of the locality serviced by its primary service provider network and a TD associated with an SLS subscriber, such as subscriber TD 110, that is situated outside of the locality serviced by its primary service provider network is described. This particular embodiment involves a data communication for the implementation of the SLS. It is envisioned that the data communication may be of any protocol suitable for data communicating over communications network 125 including the use of protocols and standards such as, but not limited to, SS7 protocol suite, SIP, CAMEL or CAP, ROSE, VOIP, etc.

In the particular calling scenarios applicable to the FIG. 4 method, although the third party does not incur a long-distance or roaming fee for calling the SLS phone number, because the SLS phone number is a local phone number relative to the third party TD 120, the SLS subscriber may incur a roaming fee for the call between the subscriber TD 110 and the SLS platform 115 when using the voice channel of communications network 125 even if the relationship number involved in the call is associated with the network servicing the present locality of the subscriber TD 110. Put another way, even if the relationship number is a local phone number relative to the present locality of the subscriber TD 110, the SLS subscriber may incur a roaming fee for directing to or receiving a call from the relationship number. Consequently, the primary service provider of the SLS subscriber may exact a roaming charge (i.e., generate an invoice or a bill) for the call between the subscriber TD 110 to the SLS platform 115. Subsequently, the SLS provider associated with the SLS platform 115 may also exact a charge, albeit not a roaming charge because the SLS phone number is local relative to the third party TD 120, to the subscriber for the call between the SLS platform 115 and the third party TD 120. It is envisioned that this potential for a single roaming charge as described relative to the FIG. 4 method may be cumbersome and less than optimal.

Accordingly, the exemplary method 500 includes an SLS module 105 configured to either access a data communication so as to avoid a voice channel call between the subscriber TD 110 and the SLS platform 115 for the SLS that would incur a roaming charge to the SLS subscriber. The call between the subscriber TD 110 and the SLS platform 115 for the SLS may be over a data channel of communications network 125, as would be understood by one of ordinary skill in the art. For embodiments of an SLS that use a data communication, it is envisioned that:
1) Billing and/or reporting a call between the subscriber TD 110 and the SLS platform 115 by the SLS subscriber's primary service provider supplying the primary phone number of the subscriber TD 110 may be avoided;
2) Because billing and/or reporting by the SLS subscriber's primary service provider is avoided regarding a call between the subscriber TD 110 and the SLS platform 115, the subscriber may not see and be confused by a call listed on his primary phone number invoice as being placed to an otherwise hidden relationship number instead of to the recognizable third party number he actually dialed;
3) Any charges imposed by the SLS subscriber's primary service provider may be limited to roaming data plan charges;
4) The SLS provider may be positioned to minimize the charges it imposes on the SLS subscriber for the call between the SLS platform 115 and the third party TD 120 because it may have issued and used a local SLS phone number for the SLS; and
5) The third party may be positioned to minimize the charges imposed on it by its primary service provider for the call between the SLS platform 115 and the third party TD 120 because the SLS phone number is a local number relative to it.

FIGS. 5A-5D collectively illustrate an exemplary method 500 for implementing an SLS call between a third party TD, such as third party TD 120 that is situated inside of the locality serviced by its primary service provider network, and a TD associated with an SLS subscriber, such as subscriber TD 110 that is situated outside of the locality serviced by its primary service provider network, using a data communication for the SLS. Depending on whether the primary service provider is different from the second line service provider or the primary service provider and the second line service provider are the same provider, embodiments of the systems and methods may use CAP protocols and/or other protocols that would occur to those with ordinary skill in the art.

Like method 400, the SLS phone number for subscriber TD 110 issued by the SLS provider is a phone number associated with the network servicing the present locality of the subscriber TD 110 (in FIG. 3, this network is represented by first provider network 201/second provider network 202—this is also the primary network of third party TD 120). As such, the SLS phone number is a local phone number relative to the primary phone number of third party TD 120 and any calls directed to or directed from the SLS phone number route through first provider network 201/second provider network 202.

At block 502, a call is directed to and received by an SLS platform 115. Notably, the call is envisioned to be any communication over communications network 125 that is directed to SLS platform 115, regardless of whether such communication originates from a subscriber TD 110 or a third party TD 120. One of ordinary skill in the art will recognize that a communication may include the use of protocols and standards such as, but not limited to, SS7 protocol suite, SIP, CAMEL or CAP, ROSE, VOIP, etc.

Next, at decision block 504, the SLS platform 115 determines whether the call originated from a third party TD 120 directed to an SLS subscriber, i.e., whether a third party has dialed an SLS phone number associated with an active SLS subscriber. If the communication was not a call that originated from a third party TD 120, then the “no” branch is followed to block 532 of FIG. 5C. If the call did, in fact, originate from a third party TD 120, then the “yes” branch is followed to block 506. Notably, if a call is directed to the SLS platform 115, one of ordinary skill in the art will recognize that the communication was either a call to an SLS phone number (if dialed by a third party TD 120), a call directed to a relationship number (if originating from an SLS client of a subscriber TD 110), or a data communication originating from an SLS client of a subscriber TD 110 (not depicted in the figures). Moreover, the communication was a call directed to a relationship number, the call between the subscriber TD 110 and the SLS platform 115 may be a data communication routed through data channel of subscriber TD 110 (accessed through its roaming data service).

At block 506, the SLS platform 115 queries central SLS database 116 for the phone number being used by third party TD 120 in association with the SLS phone number that caused the call to be routed to the SLS platform 115. Notably, because the SLS phone number is a local phone number relative to the third party TD 120, the third party does not incur a long-distance or roaming fee for calling the SLS phone number. If at decision block 508, the SLS platform 115 successfully queries the phone number being used by third party TD 120 and SLS phone number combination, then the “yes” branch is followed to block 522 of FIG. FB. If the phone number being used by third party TD 120 and SLS phone number combination are not successfully queried, then the “no” branch is followed to block 510.

At block 510, the SLS platform 115 may associate a new relationship number with the phone number being used by third party TD 120 to make the call, the SLS subscriber's primary phone number and the subscriber's SLS phone number. It is envisioned that this associating may take into consideration subscriber TD 110 being presently situated outside of the locality serviced by its primary service provider network and in the same locality serviced by the third party TD 120's primary service provider. One of ordinary skill in the art will recognize that that the SLS provider, the SLS platform 115, etc. can determine the location of an SLS subscriber through a variety of system or methods. Non-limiting examples of these methods and system include GPS location service on the TD, access to the geographic information of the network, direct communication with the SLS subscriber as to their immediate location, etc.

At block 512, the central SLS database 116 is updated to include the newly created record—the phone number being used by third party TD 120 to make the call is listed as a contact of the SLS subscriber in the Subscriber Relationship ID Table 310. At block 514, a call is established between the SLS platform 115 and the subscriber TD 110 using a data communication as opposed to a voice channel communication. In some non-limiting embodiments of block 514, the SLS platform 115 initiates the call through the communication network 125's data channel with the subscriber TD 110 by using SIP and/or CAMEL. In other non-limiting embodiments of block 514, the subscribers TD 110 initiates the call through the communication network 125's data channel with the SLS platform 115 by using SIP and/or CAMEL; the subscriber TD 110 directs the call to the relationship number of block 510 after receiving a separate data communication from the SLS platform 115 with information containing the relationship number of block 510 and instructions to initiate the call. In certain non-limiting embodiments of block 514, the SLS platform 115 may populate the CLID field of the call between it and the subscribers TD 110 with a combination of the newly assigned relationship number and the phone number being used by third party TD 120 to make the call.

At block 516, the local SLS database 106 updates to include the newly assigned relationship number in association with the phone number being used by third party TD 120 to make the call. At block 518, the phone number being used by third party TD 120 to make the call is displayed to the SLS subscriber and the SLS subscriber is alerted to the incoming call. Notably, it is envisioned that displaying the phone number being used by third party TD 120 to make the call may include rendering the CLID field itself, rendering a picture of the third party, rendering a name, etc. as is understood by those with ordinary skill in the art of graphical user displays and interfaces. At block 520, the call from block 502 is bridged with the data communication leg from block 514 resulting in an active call between third party TD 120 and subscriber TD 110. One of ordinary skill in the art will recognize that there are many systems and methods known and understood for bridging or connecting a plurality of separate calls (the legs of the SLS); consequently, this disclosure is not limited by the used example “bridged.”

It is envisioned that the steps taken at block 518 of the method 500 may differ in some embodiments. For instance, when a third party TD 120's call to an SLS phone number is received at the SLS platform 115, and the phone number being used by third party TD 120 to make the call is not yet associated with a relationship number, the SLS platform 115 may assign a next relationship number as described relative to blocks 510-512 then establish a call with the subscriber TD 110 as described in 514. The SLS module 105 of the subscriber TD 110, having no record of the new relationship number in its local database 106, may display the calling number as “unknown caller” on the display of the subscriber TD 110. At the same time, the SLS module 105 may use the established data communication of block 514, or establish another separate and distinct data communication, over communications network 125 with the SLS platform 115 for the purpose of acquiring the third party calling number associated with the new relationship number. Once the phone number being used by third party TD 120 to make the call is acquired, the SLS module 105 may update the local database 106 and change the display from “unknown caller” to the phone number being used by third party TD 120 to make the call.

Turning now to FIG. 5B, if the “yes” branch is followed from decision block 508 of FIG. 5A, at block 522 the SLS platform 115 queries the central SLS database 116 for the relationship number that maps to the combination of the phone number being used by third party TD 120 and subscriber's SLS phone number. At block 523, the SLS platform 115 determines if it should modify the relationship number of block 522 based on the location of the subscriber TD 110. If at decision block 523 the SLS platform 115 determines that it should modify the relationship number of block 522 based on the location of the subscriber TD 110, then the “yes” branch is followed to block 510 of FIG. 5A. (Again, one of ordinary skill in the art will recognize that that the SLS provider, the SLS platform 115, etc. can determine the location of an SLS subscriber through a variety of system or methods. Non-limiting examples of these methods and system include GPS location service on the TD, access to the geographic information of the network, direct communication with the SLS subscriber as to their immediate location, etc.). If at decision block 523 the SLS platform 115 determines that it should not modify the relationship number of block 522 based on the location of the subscriber TD 110, then the “no” branch is followed to block 524.

At block 524, a call is established between the SLS platform 115 and the subscriber TD 110 using a data communication. In some non-limiting embodiments of block 524, the SLS platform 115 initiates the call through the communication network 125's data channel with the subscriber TD 110 by using SIP and/or CAMEL. In other non-limiting embodiments of block 524, the subscriber's TD 110 initiates the call through the communication network 125's data channel with the SLS platform 115 by using SIP and/or CAMEL; the SLS platform directs the call to the relationship number of block 522 after receiving a separate data communication from the SLS platform 115 with information containing the relationship number of block 522 and instructions to initiate the call. In certain non-limiting embodiments of block 524, the SLS platform 115 may populate the CLID field of the call between it and the subscribers TD 110 with a combination of the assigned relationship number and the phone number being used by third party TD 120 to make the call.

It is envisioned that in some embodiments of block 524 an SLS module 105 may recognize that an incoming call is from the SLS platform 115 by virtue of the call being established using the data channel of communications network 125. At block 526, the phone number being used by third party TD 120 to make the call is displayed to the SLS subscriber and the SLS subscriber is alerted to the incoming call. Notably, it is envisioned that displaying the phone number being used by third party TD 120 to make the call may include rendering the CLID itself, rendering a picture of the third party, rendering a name, etc. as is understood by those with ordinary skill in the art of graphical user displays and interfaces. In certain non-limiting embodiments of block 526, the information populated by the SLS platform 115 in the CLID field of the call between SLS platform 115 and the subscribers TD 110 may cause the SLS module 105 to handle the call and display the associated third party CLID for the benefit of the subscriber.

At block 530, the call from block 502 is bridged with the call from block 524 resulting in an active call between third party TD 120 and subscriber TD 110. One of ordinary skill in the art will recognize that there are many systems and methods known and understood for bridging or connecting a plurality of separate calls (the legs of the SLS); consequently, this disclosure is not limited by the used example “bridged.” It is envisioned that, if the subscriber elects not to answer a call to the SLS phone number, the SLS module 105 in some non-limiting embodiments may use a voicemail service or message service in response to the unanswered call. That is, it is envisioned that an SLS service may provide features and services dedicated to the SLS subscriber and separate from similar features and services associated with the subscriber's primary number.

Turning now to FIG. 5C, if the “no” branch is followed from block 504 of FIG. 5A, at decision block 532 the SLS platform 115 determines if the call was directed to a relationship number using a data communication. Notably, if the call is directed to a relationship number, then it must have originated from a subscriber TD 110. If the call was not directed to a relationship number, the “no” branch is followed to block 542 of FIG. 4D. If, however, the call was routed to the SLS platform 115 because it was directed to a relationship number then the “yes” branch is followed to block 434. Notably, it is envisioned that in some embodiments the SLS platform 115 may recognize that the communication originated from a subscriber of the SLS service simply by virtue of the communication being a SIP based call.

At block 534, the central SLS database 116 is queried for the third party TD 120's phone number in combination with the relationship number at which subscriber TD 110 directed the data communication that resulted in the routing to the SLS platform 115. At block 536, the SLS platform 115 determines the third party TD 120's phone number with which the relationship number and the SLS subscriber's primary phone number combination is associated. At decision block 537, if the third party TD 120's phone number of block 536 is determined by the SLS platform 115 to be an SLS phone number, i.e., both the calling party and the called party are SLS subscribers, the method may proceed to block 539.

At block 539, a call is established between the SLS platform 115 and the third party TD 120 using a data communication. In some non-limiting embodiments of block 539, the SLS platform 115 initiates the call through the communication network 125's data channel with the third party TD 120 by using SIP and/or CAMEL. In other non-limiting embodiments of block 539, the third party TD 120 initiates the call through the communication network 125's data channel with the SLS platform 115 by using SIP and/or CAMEL; the third party TD 120 directs the call to the SLS platform 115 after receiving a separate data communication from the SLS platform 115 with information and instructions for establishing the call.

In certain non-limiting embodiments of block 539, the SLS platform 115 may populate the CLID field of the call between it and the subscribers TD 110 with a combination of the assigned relationship number and the phone number being used by third party TD 120 to make the call. It is envisioned that in some embodiments of block 539 an SLS module 105 may recognize that an incoming call is from the SLS platform 115 by virtue of the call being established using the data channel of communications network 125. In some non-limiting embodiments of block 539, the SLS platform 115 may populate the CLID field of the call between it and the third party TD 120 with the SLS phone number of subscriber TD 110. In other non-limiting embodiments of block 539, the SLS platform 115 may populate the CLID field of the call between it and the third party TD 120 with the primary phone number of subscriber TD 110.

If, however, at decision block 537 it is determined that the third party number is not an SLS phone number, i.e., the third party is not an SLS subscriber, then the method moves to block 538. At block 538, a call is established between the SLS platform 115 and the third party TD 120. In some non-limiting embodiments of block 438, the SLS platform 115 initiates the call through the communication network 125's voice channel with the third party TD 120 by dialing the third party TD 120's phone number determined in block 436. In some non-limiting embodiments of block 538, the SLS platform 115 may populate the CLID field of the call between it and the third party TD 120 with the SLS phone number of subscriber TD 110. In other non-limiting embodiments of block 538, the SLS platform 115 may populate the CLID field of the call between it and the third party TD 120 with the primary phone number of subscriber TD 110.

At block 540, whether coming from block 538 or block 539, the call from block 402 is bridged with the call from block 538 or the call from block 539 resulting in an active call between subscriber TD 110 and third party TD 120. One of ordinary skill in the art will recognize that there are many systems and methods known and understood for bridging or connecting a plurality of separate calls (the legs of the SLS); consequently, this disclosure is not limited by the used example “bridged.” It is envisioned that, if the third party elects not to answer a call to it from SLS, the SLS platform 115 in some non-limiting embodiments may continue the bridge even when the call from block 438 is routed to its voicemail service or message service.

Turning now to FIG. 5D, if the “no” branch is followed from block 532 of FIG. 5C, at decision block 542 the SLS platform 115 determines that the communication is a data communication over communications network 125 that originated from an SLS client of a subscriber TD 110. If not, then it is assumed that it was an errant communication and the “no” branch is followed to block 544 and the communication is disconnected. If the communication did originate from a SLS client, i.e., an SLS module 105 in a subscriber TD 110, associated with a subscriber to the SLS service, then the “yes” branch is followed to block 446. It is envisioned that the communication from an SLS client application to an SLS platform may be of any protocol suitable for communicating over communications network 125 including the use of protocols and standards such as, but not limited to, SS7 protocol suite, SIP, CAMEL or CAP, ROSE, VOIP, etc.

At block 546, it is deduced by the SLS platform 115 that the subscriber associated with the calling SLS client desires to use the SLS service to call third party TD 120's phone number with which no relationship number has been previously associated (such as would occur at block 510). The SLS module 105 has provided the request for the new relationship number, along with the third party number it desires to call, to the SLS platform 115 via the data communication. The central SLS database 116 is queried at block 546 to determine the next available relationship number for the subscriber's given SLS phone number.

The SLS platform 115 may associate a new relationship number with the subscriber's SLS phone number, the SLS subscriber's primary phone number and the third party TD 120's phone number. It is envisioned that this associating may take into consideration subscriber TD 110 being presently situated outside of the locality serviced by its primary service provider network and in the same locality serviced by the third party TD 120's primary service provider. One of ordinary skill in the art will recognize that that the SLS provider, the SLS platform 115, etc. can determine the location of an SLS subscriber through a variety of system or methods. Non-limiting examples of these methods and system include GPS location service on the TD, access to the geographic information of the network, direct communication with the SLS subscriber as to their immediate location, etc.

It is envisioned that the SLS module 105 may communicate with the SLS platform 115 in some embodiments to obtain a relationship number for a third party that has not previously been called via a session-based protocol such as, but not limited to, an unstructured supplementary services data (“USSD”) protocol. As is understood in the art of telecommunications protocols, a gateway such as a USSD gateway may be used to route messages from a signaling network to service applications and back. In this way, certain embodiments of an SLS module 105 may communicate with an SLS platform 115 to designate and acquire a relationship number to a third party who has not been called by the subscriber before via the SLS (or, for that matter, a third party who has not placed a call to the subscriber's SLS phone number before).

Moreover, USSD is offered herein for exemplary purposes and is not meant to limit the type of communications protocol that may be used by certain embodiments. For example, it is envisioned that short message service (“SMS”) protocol, multimedia messaging service (“MMS”) protocol, and/or other protocols may be used by some embodiments. It is envisioned that an IP-based interaction over the TD's data service may be used by some embodiments. As would be recognized by one of ordinary skill in the art, use of session based protocols or other communication protocols may minimize temporal delays in allocating and acquiring relationship numbers between an SLS module 105 and an SLS platform 115. In fact, it is anticipated that any mechanism that can be used to establish a communication path between the SLS module 105 and the SLS platform 115 for the purposes of supporting the SLS can be utilized. This may include any of the varieties of cellular data, WiFi, Bluetooth technologies, proprietary wireless or wired technologies, etc. Such channels can be used in setting up the relationship databases, sharing information between the SLS module 105 and the SLS platform 115, initiating voice communication establishment from the TD 110 to the SLS platform 115, the TD 110 requesting the SLS platform 115 to place a call to a third party TD 120, etc.

Returning to the method 500, at block 548 the determined next available relationship number is returned to the SLS module 105 of the subscriber TD 110 using data communication. At block 550, the central SLS database 116 is updated with the new relationship number. The new relationship number is now associated in the central SLS database 116 with the subscriber's SLS phone number, the SLS subscriber's primary phone number and the third party TD 120's phone number. Notably, after blocks 548 and/or 550, the method 400 may return to the start of method 400 at block 402 as the SLS module 105 of the subscriber TD 110 has acquired a new relationship number in association with a third party TD 120's phone number. Consequently, using the newly acquired relationship number may essentially start over the method 500 with the SLS platform 115 receiving the call. If so, the method 4500 would follow to FIG. 5C where the call was recognized as the subscriber TD 110 having placed a call to the new relationship number.

Certain steps or blocks in the processes or process flows described in this specification naturally precede others for the invention to function as described. However, the invention is not limited to the order of the steps or blocks described if such order or sequence does not alter the functionality of the invention. That is, it is recognized that some steps or blocks may performed before, after, or parallel (substantially simultaneously with) other steps or blocks without departing from the scope and spirit of the invention. In some instances, certain steps or blocks may be omitted or not performed without departing from the invention. Also, in some instances, multiple actions depicted and described as unique steps or blocks in the present disclosure may be comprised within a single step or block. Further, words such as “thereafter”, “then”, “next”, “subsequently”, etc. are not intended to limit the order of the steps or blocks. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, acoustic and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for servicing a communication request originating from a first telecommunications device (“TD”) and directed to a second TD, wherein the second TD has at least one second line service (“SLS”) phone number assigned therewith, the SLS phone number being associated with a primary service provider network of a first TD, and wherein the first TD is being serviced by its primary service provider network and the second TD is roaming on the primary service provider network of the first TD, the method comprising an SLS platform performing the actions of:
receiving a communication setup request that is initiated from a first TD and that is directed to an SLS phone number of a second TD, the first TD and the second TD being communicatively coupled to and being communicatively coupled through a primary service provider network of the first TD, and an SLS platform being communicatively coupled to the primary service provider network and, thus, to the first TD and the second TD;
identifying, based on the SLS phone number to which the communication setup request is directed and a phone number being used by the first TD to initiate the communication setup request, a relationship number, which is associated with the SLS phone number and the phone number of the first TD, and a primary phone number of the second TD, which is associated with the SLS phone number and the phone number of the first TD;
establishing a communication path between the first TD and the second TD based at least in part on the relationship number; and
providing the phone number being used by the first TD to initiate the communication setup request to the second TD.

2. The method of claim 1, additionally comprising the SLS platform performing the action of associating the relationship number with (1) the phone number of the first TD, (2) the SLS phone number and (3) a primary phone number of the second TD such that the association can be queried to perform the identifying action.

3. The method of claim 2, additionally comprising the SLS platform performing the action of storing in an SLS database communicatively coupled to the SLS platform, the associated numbers of the associating action.

4. The method of claim 1, wherein establishing the communication path between the first TD and the second TD additionally comprises the SLS platform performing the action of initiating a voice call from the relationship number to the primary phone number of the second TD.

5. The method of claim 4, wherein initiating a voice call to the primary phone number of the second TD additionally comprises the SLS platform performing the action of establishing a data communication with the second TD.

6. The method of claim 1, wherein establishing the communication path between the first TD and the second TD additionally comprises the SLS platform performing the action of instructing the second TD to initiate a second communication setup request from the primary phone number of the second TD that is directed to the relationship number.

7. The method of claim 1, wherein establishing the communication path between the first TD and the second TD additionally comprises the SLS platform performing the action of instructing the second TD to establish a data communication with the SLS platform.

8. The method of claim 4, wherein initiating a voice call to a primary phone number of the second TD additionally comprises the SLS platform performing the action of bridging voice calls.

9. The method of claim 4, wherein initiating a voice call to a primary phone number of the second TD additionally comprises the SLS platform performing the action of routing voice calls.

10. A method for servicing a communication request originating from a first telecommunications device (“TD”) and directed to a second TD, wherein the first TD has at least one second line service (“SLS”) phone number assigned therewith, the SLS phone number being associated with a primary service provider network of a second TD, and wherein the second TD is being serviced by its primary service provider network and the first TD is roaming on the primary service provider network of the second TD, the method comprising an SLS platform performing the actions of:
receiving a communication setup request that is initiated from a first TD and that is directed to a relationship number, the first TD and a second TD being communicatively coupled to and being communicatively coupled through a primary service provider network, and an SLS platform being communicatively coupled to the primary service provider network and, thus, to the first TD and the second TD;
identifying, based on the relationship number and a primary phone number from which the first TD directed the communication setup request, a phone number for the second TD, which is associated with the relationship number and the primary phone number, and an SLS phone number of the first TD, which is associated with the relationship number and the primary phone number;
establishing a communication path between the first TD and the second TD based at least in part on the relationship number; and
providing the SLS phone number to the second TD.

11. The method of claim 10, additionally comprising the SLS platform performing the action of assigning an additional SLS phone number to the second TD at the SLS platform, the additional SLS phone number being associated with the primary service provider network of the second TD.

12. The method of claim 10, additionally comprising the SLS platform performing the actions of:
receiving a data communication that is initiated by the first TD; and
transmitting the relationship number to the first TD with the data communication.

13. The method of claim 10, wherein receiving a communication setup request additionally comprising the SLS platform performing the action of receiving a data communication that is initiated by the first TD.

14. The method of claim 10, additionally comprising the SLS platform performing the action of associating the relationship number with (1) the phone number for the second TD, (2) the SLS phone number and (3) the primary phone number of the first TD such that the association can be queried by the SLS platform to perform the identifying action.

15. The method of claim 14, additionally comprising the SLS platform performing the action of storing in an SLS database communicatively coupled to the SLS platform, the associated numbers of the associating action.

16. The method of claim 10, wherein establishing the communication path between the first TD and the second TD additionally comprises the SLS platform performing the action of initiating a voice call from the SLS phone number directed to the phone number of the second TD.

17. The method of claim 16, wherein initiating the voice call from the SLS phone number directed to the phone number of the second TD additionally comprises the SLS platform performing the action of establishing a data communication with the second TD.

18. The method of claim 10, wherein establishing the communication path between the first TD and the second TD additionally comprises the SLS platform performing the action of instructing the second TD to initiate a data communication with the SLS platform.

19. The method of claim 16, wherein initiating a voice call from the SLS phone number directed to the phone number of the second TD additionally comprises the SLS platform performing the action of bridging voice calls.

20. The method of claim 16, wherein initiating a voice call from the SLS phone number directed to the phone number of the second TD additionally comprises the SLS platform performing the action of routing voice calls.
